(19) United States
(12) Patent Application Publication
(10) Pub. No.: US 2023/0238545 A1
(43) Pub. Date: Jul. 27, 2023

(54) CARBON-BASED CALCINED MATERIAL AND COMPLEX THEREOF AS WELL AS FUEL CELL USING THE CARBON-BASED CALCINED MATERIAL

(71) Applicant: NISSAN CHEMICAL CORPORATION, Tokyo (JP)

(72) Inventors: Shoichi KONDO, Funabashi-shi (JP); Hirokazu KATO, Funabashi-shi (JP); Takamasa KIKUCHI, Funabashi-shi (JP); Norihito SHIGA, Funabashi-shi (JP)

(73) Assignee: NISSAN CHEMICAL CORPORATION, Tokyo (JP)

(21) Appl. No.: 18/007,997

(22) PCT Filed: May 31, 2021
(86) PCT No.: PCT/JP2021/020651

§ 371 Date: Dec. 2, 2022

(30) Foreign Application Priority Data
Jun. 4, 2020 (JP) 2020-097936
Sep. 1, 2020 (JP) 2020-146758
Jan. 20, 2021 (JP) 2021-007385

(51) Int. Cl. H01M 4/96; C09C 1/56; C01B 32/168; H01M 8/1004

(52) U.S. Cl. CPC H01M 4/96; C09C 1/56; C01B 32/168; H01M 8/1004; C01B 2202/22; C01P 2006/40; C01P 2002/82; H01M 2008/1095

(57) ABSTRACT

A stable form which uses a carbon material having electrical conductivity as a raw material and that the electrical conductivity of the carbon material is retained and/or improved, and which improves the electricity generation properties when used in a catalyst layer for a fuel cell. The present invention is directed to, e.g., a calcined material of a mixture of an aromatic compound having a phenolic hydroxyl group and a carbon material having electrical conductivity.

### FIELD OF THE INVENTION

The present invention relates to a carbon-based calcined material and a complex thereof as well as a fuel cell using the calcined material.

### BACKGROUND ART

Carbon black is a carbon material and in the form of submicron-size particles composed of amorphous carbon, and examples of uses of carbon black include a rubber reinforcing agent, a resin coloring agent, a printing ink, a coating composition, and an electrode material (non-patent document 1). There is such carbon black that addition of a small amount of the carbon black can impart electrical conductivity, and such carbon black is called conductive carbon black, and, according to the methods for producing carbon black and raw materials for the carbon black, there have been known various types of carbon black, such as acetylene black, oil furnace black, vulcan, ketjen black, and ketjen black EC (non-patent document 2).

With respect to the carbon black which is a carbon material, it has been known that the production and activation treatment for carbon black are conducted at high temperatures, and thus part of the functional groups on the surface of the carbon black are removed and graphitization proceeds, so that the resultant carbon black can obtain high electrical conductivity (non-patent document 3).

Carbon nanotube, which is a carbon material, is formed from a hexagonal plane in a cylindrical shape composed of sp² carbons of carbon isotope, and there are single-walled carbon nanotubes and multi-walled carbon nanotubes. For example, as carbon nanotubes which are produced on a commercial scale and on the market, carbon nanotubes of a vapor growth carbon fiber type have been known, and have excellent electrical conductivity (non-patent document 4).

### PRIOR ART REFERENCES

### Non-Patent Documents

Non-patent document 1: Shin⋅Tanso Zairyou Nyuumon (New Guide to Carbon Materials), edited by The Carbon Society of Japan, published by Realize Science & Engineering, “2.8 Carbon Black”, 1996, pages 129-135
Non-patent document 2: Kaabon Zairyou Jikken Gijutsu (Seizou⋅Gousei Hen) {Experimental Technique for Carbon Materials (Book of Production and Synthesis)}, edited by Serial Lecture Editorial Board of The Carbon Society of Japan, “Chapter 3, 3-3 Conductive Carbon Black ‘Ketjen Black EC’”, 2013, pages 173-179
Non-patent document 3: Kaabon Zairyou Jikken Gijutsu (Seizou⋅Gousei Hen) {Experimental Technique for Carbon Materials (Book of Production and Synthesis)}, edited by Serial Lecture Editorial Board of The Carbon Society of Japan, “Chapter 3, 3-1 Carbon Black”, 2013, pages 156-167
Non-patent document 4: Kaabon Zairyou Jikken Gijutsu (Seizou⋅Gousei Hen) {Experimental Technique for Carbon Materials (Book of Production and Synthesis)}, edited by Serial Lecture Editorial Board of The Carbon Society of Japan, “Chapter 2, 2-3 Production Method and Application of Vapor Growth Carbon Fiber”, 2013, pages 87-91

### SUMMARY OF THE INVENTION

### Problems to be Solved by the Invention

With respect to the carbon material having electrical conductivity, for example, conductive carbon black is improved in electrical conductivity by reducing the surface functional groups and deficient portions by calcination at a high temperature, and therefore the amount of the surface functional groups of carbon black is small. Further, carbon nanotube, which is a carbon material, is composed of sp² carbons, and hence functional groups on the surface of carbon nanotube are concentrated on edge sites of the tube and deficient sites in a slight amount, and the amount of functional groups present on the carbon nanotube is very small.

With respect to the improvement of carbon black and carbon nanotube through the surface functional group, for example, imparting other functions or improving the function, the carbon black and carbon nanotube can be improved through the surface functional group without lowering the inherent electrical conductivity function by, for example, chemical modification according to an organic synthesis method, or a method of introducing another material into the surface of carbon black by adsorption, but it has been difficult to achieve practically significant improvement. For example, in the case of chemical modification, the amount of the functional groups originally present on the surface of the carbon material having electrical conductivity is small, and therefore the amount of the functional groups that can be introduced by chemical modification is limited, and, when another functional group is introduced into the surface composed of sp² carbons using a covalent bond, it is likely that, according to the amount of the functional group introduced, the inherent electrical conductivity function of the carbon material becomes poor. Meanwhile, in the method of adsorbing another material on the surface of the carbon material having electrical conductivity, such physical adsorption is likely to easily cause desorption of the material, so that the properties of the material cannot be retained but become poor.

An object of the present invention is to achieve a stable form which uses a carbon material having electrical conductivity as a raw material and is in such a stable form that the electrical conductivity of the carbon material is retained and/or improved, and which improves the electricity generation properties when used in a catalyst layer for a fuel cell.

### Means for Solving the Problems

The present inventors have conducted extensive and intensive studies. As a result, it has been found that, by subjecting a mixture of a conventional carbon material having electrical conductivity and an aromatic compound having a phenolic hydroxyl group to reaction for calcination, a novel calcined material is obtained, and, when the obtained calcined material is used as, for example, an electrolyte and/or a catalyst carrier in a catalyst layer for a fuel cell or an electrolyte in a polymer electrolyte membrane, the catalyst layer is improved in the proton conductive properties, electronic conductive properties, water transport, and gas permeability, achieving excellent electricity generation properties.

The present inventors have conducted extensive and intensive studies. As a result, it has been found that a calcined material is obtained by a method for producing in which a mixture of a conventional carbon material having electrical conductivity and an aromatic compound having a phenolic hydroxyl group is calcined at a temperature which is the melting point of the aromatic compound having a phenolic hydroxyl group or higher to form a composite calcined material, or a method for producing in which a mixture of a carbon material having electrical conductivity and an organic solvent solution of an aromatic compound having a phenolic hydroxyl group is obtained and then calcined at a specific temperature to form a composite calcined material, and, when the obtained calcined material is used as, for example, an electrolyte and/or a catalyst carrier in a catalyst layer for a fuel cell or an electrolyte in a polymer electrolyte membrane, the catalyst layer is improved in the proton conductive properties, electronic conductive properties, water transport, and gas permeability, achieving excellent electricity generation properties.

The present inventors have further conducted extensive and intensive studies. As a result, it has been found that, by conducting a reaction for introducing a rare earth metal ion into the above-mentioned calcined material, a complex of a rare earth metal ion and the calcined material is obtained, and the obtained complex improves the proton conductive properties and electronic conductive properties, achieving excellent electricity generation properties.

The present invention is, for example, the following items [1] to [20].

[1] A carbon-based calcined material of a mixture of an aromatic compound having a phenolic hydroxyl group and a carbon material having electrical conductivity.

[2] The carbon-based calcined material according to item [1] above, wherein the aromatic compound having a phenolic hydroxyl group is an aromatic compound having 2 to 6 phenolic hydroxyl groups.

[3] The carbon-based calcined material according to item [1] or [2] above, wherein the carbon material having electrical conductivity is at least one kind selected from the group consisting of ketjen black, ketjen black EC, and carbon nanotube.

[4] A method for producing the carbon-based calcined material according to any one of items [1] to [3] above, the method comprising the step of obtaining a mixture of a fused liquid or organic solvent solution of an aromatic compound having a phenolic hydroxyl group and a carbon material having electrical conductivity.

[5] The method for producing the carbon-based calcined material according to item [4] above, wherein the method comprises the steps of:

(step 1) obtaining a mixture of an aromatic compound having a phenolic hydroxyl group and a carbon material having electrical conductivity, and

(step 2) calcining the mixture obtained in the step 1 at a temperature which is the melting point of the aromatic compound having a phenolic hydroxyl group or higher.

[6] The method for producing the carbon-based calcined material according to item [4] above, wherein the method comprises the steps of:

(step 1) obtaining a mixture of an organic solvent solution of an aromatic compound having a phenolic hydroxyl group and a carbon material having electrical conductivity, and

(step 2) calcining the mixture obtained in the step 1 at a temperature in the range of from 150 to 600° C.

[7] A complex of the calcined material according to any one of items [1] to [3] above and a rare earth metal ion, wherein the rare earth metal ion and the substituent of the calcined material form a complex.

[8] The complex according to item [7] above, wherein the metal species of the rare earth metal ion is at least one kind selected from the group consisting of scandium, yttrium, lanthanum, cerium, praseodymium, neodymium, promethium, samarium, europium, gadolinium, terbium, dysprosium, holmium, erbium, thulium, ytterbium, and lutetium.

[9] The complex according to item [7] or [8] above, wherein the substituent of the calcined material is at least one kind selected from the group consisting of a hydroxyl group, a carboxyl group, a carbonyl group, a formyl group, a sulfonic acid group, an oxysulfonic acid group, a carboxylic acid anhydride structure, a chromene structure, a lactone structure, an ester structure, and an ether structure, which are derived from the carbon material having electrical conductivity, and a hydroxyl group derived from the aromatic compound having a phenolic hydroxyl group.

[10] A method for producing the complex according to any one of items [7] to [9] above, the method comprising reacting a rare earth metal compound and the calcined material according to any one of claims 1 to 3 in a solvent.

[11] The method for producing according to item [10] above, wherein the rare earth metal compound is at least one kind selected from the group consisting of CeBr₃, CeCl₃·7H₂O, CeF₃, CeF₄, CeI₃, EuBr₃·xH₂O, EuCl₂, EuCl₃, EuCl₃·6H₂O, EuF₃, EuI₂, NdBr₃, NdCl₃, NdCl₃·6H₂O, NdF₃, NdI₂, NdI₃, SmBr₃, SmCl₃, SmCl₃·6H₂O, SmI₂, SmI₃, Ce(NH₄)₂(NO₃)₆, Ce(NO₃)₃·6H₂O, Nd(NO₃)₃·6H₂O, Ce(CH₃CO₂)₃·xH₂O, Ce(C₅H₇O₂)₃·xH₂O, Eu(CH₃CO₂)₃·xH₂O, CeO₂, Eu₂O₃, Nd₂O₃, Sm₂O₃, Sc₂O₃, (CeO₂)(ZrO₂), and samarium triisopropoxide.

[12] A method for producing the complex according to any one of items [7] to [9] above, the method comprising calcining a mixture of a rare earth metal compound and the calcined material according to any one of items [1] to [3] above.

[13] The method for producing according to item [12] above, wherein the rare earth metal compound is at least one kind selected from the group consisting of Ce(CH₃CO₂)₃·xH₂O, Ce(C₅H₇O₂)₃·xH₂O, Eu(CH₃CO₂)₃·xH₂O, Gd(CH₃CO₂)₃·xH₂O, Gd(C₅H₇O₂)₃·xH₂O, La(CH₃CO₂)₃·xH₂O, La(C₅H₇O₂)₃·xH₂O, Tb(CH₃CO₂)₃·xH₂O, Yb(C₂H₃O₂)₃·4H₂O, cerium triisopropoxide, samarium triisopropoxide, tris(acetylacetonato)cerium(III), and tris(acetylacetonato)samarium(III).

[14] The calcined material according to any one of items [1] to [3] above or the complex according to any one of items [7] to [9] above, which is at least one kind of an electrolyte in a catalyst layer, a catalyst carrier in the catalyst layer, and an electrolyte in a polymer electrolyte membrane, for a polymer electrolyte fuel cell.

[15] A composition comprising at least one kind selected from the group consisting of the calcined material according to any one of items [1] to [3] above and the complex according to any one of items [7] to [9] above, and a metal catalyst.

[16] The composition according to item [15] above, which is for use in a catalyst layer for a polymer electrolyte fuel cell.

[17] A catalyst layer for a polymer electrolyte fuel cell, the catalyst layer comprising the composition according to item [15] above.

[18] A membrane electrode assembly comprising a polymer electrolyte membrane, a gas diffusion layer, and the catalyst layer for a polymer electrolyte fuel cell according to item [17] above.

[19] The membrane electrode assembly according to item [18] above, wherein the polymer electrolyte membrane has a thickness of 10 to 100 μm.

[20] A polymer electrolyte fuel cell comprising the membrane electrode assembly according to item [18] or [19] above.

### Effects of the Invention

The carbon-based calcined material and complex of the present invention use a carbon material having electrical conductivity as part of raw materials and are in a stable form, and improve the electricity generation properties when used in a catalyst layer for a fuel cell.

### BRIEF DESCRIPTION OF THE DRAWINGS

FIG. 1 A cross-sectional view diagrammatically showing the construction of a polymer electrolyte fuel cell.

FIG. 2 An IR measurement chart of calcined material (1).

FIG. 3 An IR measurement chart of ketjen black EC (EC300J).

FIG. 4 An IR measurement chart of calcined material (7).

### MODE FOR CARRYING OUT THE INVENTION

In the present specification, “n-” means normal, “s-” means secondary, “t-” means tertiary, “o-” means ortho, “m-” means meta, and “p-” means para.

<<Calcined Material>>

The present invention is directed to a carbon-based calcined material of a mixture of an aromatic compound having a phenolic hydroxyl group and a carbon material having electrical conductivity.

<Aromatic Compound Having a Phenolic Hydroxyl Group>

With respect to the aromatic compound having a phenolic hydroxyl group, examples include compounds having at least one phenolic hydroxyl group, which are monocyclic or fused polycyclic aromatic compounds.

Especially, there can be mentioned mono-, di-, tri-, tetra-, penta-, or hexa-hydric phenols which are monocyclic aromatic compounds having 1 to 6 phenolic hydroxyl groups.

Examples of phenols having one phenolic hydroxyl group, which are monocyclic aromatic compounds, include phenol, ethylphenol, p-t-butylphenol, o-cresol, m-cresol, p-cresol, 2,3-xylenol, 2,4-xylenol, 2,5-xylenol, 2,6-xylenol, thymol, mesitol, pseudocumenol, 2,6-di-t-butyl-p-cresol, pentamethylphenol, o-hydroxystyrene, m-hydroxystyrene, p-hydroxystyrene, chavicol, o-allylphenol, anol, diethylstilbestrol, p-(methylthio)phenol, o-aminophenol, m-aminophenol, p-aminophenol, o-(methylamino)phenol, m-(methylamino)phenol, p-(methylamino)phenol, m-(dimethylamino)phenol, o-anilinophenol, m-anilinophenol, p-anilinophenol, 2-amino-p-cresol, 3-amino-o-cresol, 3-amino-p-cresol, 4-amino-o-cresol, 4-amino-p-cresol, 5-amino-o-cresol, 6-amino-m-cresol, 2,4-diaminophenol, and 2,4,6-triaminophenol.

Examples of phenols having two phenolic hydroxyl groups, which are monocyclic aromatic compounds, include catechol, resorcinol, hydroquinone, 3,4-toluenediol, 2,5-toluenediol, 3,5-toluenediol, 2,4-toluenediol, urushiol, p-xylene-2,6-diol, m-xylene-4,6-diol, p-xylene-2,5-diol, and 2-isopropyl-5-methylhydroquinone.

Examples of phenols having 3 phenolic hydroxyl groups, which are monocyclic aromatic compounds, include pyrogallol, 1,2,4-benzenetriol, phloroglucinol, 2-methylphloroglucinol, m-xylene-2,4,6-triol, and 2,4,6-trimethylphloroglucinol.

Examples of phenols having 4 phenolic hydroxyl groups, which are monocyclic aromatic compounds, include 1,2,3,5-benzenetetraol and 1,2,4,5-benzenetetraol.

Examples of phenols having 6 phenolic hydroxyl groups, which are monocyclic aromatic compounds, include hexahydroxybenzene.

With respect to the monocyclic aromatic compound having a phenolic hydroxyl group, from the viewpoint of obtaining excellent electricity generation properties, preferred are di-, tri-, tetra-, penta-, or hexa-hydric phenols which are monocyclic aromatic compounds having 2 to 6 phenolic hydroxyl groups, more preferred are tri-, tetra-, penta-, or hexa-hydric phenols which are monocyclic aromatic compounds having 3 to 6 phenolic hydroxyl groups, further preferred are trihydric phenols which are monocyclic aromatic compounds having 3 phenolic hydroxyl groups, and especially preferred is phloroglucinol represented by the following formula (I).

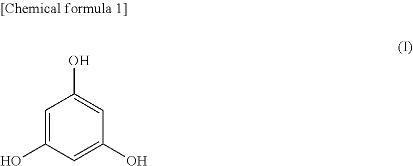

Examples of fused polycyclic aromatic compounds include naphthalene, azulene, heptalene, biphenylene, acenaphthylene, fluorene, phenalene, phenanthrene, anthracene, aceanthrylene, triphenylene, pyrene, chrysene, tetracene, perylene, pentacene, picene, and coronene, and, from the viewpoint of obtaining excellent electricity generation properties, preferred are naphthalene, anthracene and triphenylene.

Examples of fused polycyclic aromatic compounds having a phenolic hydroxyl group include 1,2-dihydroxynaphthalene, 1,3-dihydroxynaphthalene, 1,4-dihydroxynaphthalene, 1,5-dihydroxynaphthalene, 1,6-dihydroxynaphthalene, 2,3-dihydroxynaphthalene, 2,4-dihydroxynaphthalene, 2,5-dihydroxynaphthalene, 2,6-dihydroxynaphthalene, 1,3,8-trihydroxynaphthalene, 9,10-dihydroxyanthracene, and 2,3,6,7,10,11-hexahydroxytriphenylene, preferred examples include fused polycyclic aromatic compounds having 2 to 6 phenolic hydroxyl groups, more preferred examples include 2,6-dihydroxynaphthalene, 1,3,8-trihydroxynaphthalene, 9,10-dihydroxyanthracene, and 2,3,6,7,10,11-hexahydroxytriphenylene, and further preferred examples include 2,3,6,7,10,11-hexahydroxytriphenylene represented by the following formula (II).

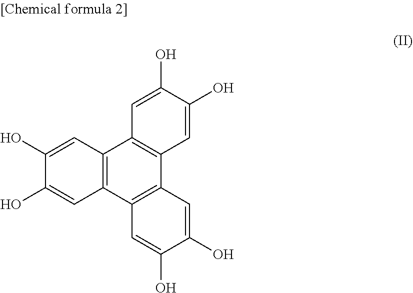 [SMILES: Oc1cc2c3cc(O)c(O)cc3c3cc(O)c(O)cc3c2cc1O]

The aromatic compounds having a phenolic hydroxyl group may be used a single kind alone or may be used in combination of two or more kinds.

<Carbon Material Having Electrical Conductivity>

With respect to the carbon material having electrical conductivity (hereinafter, frequently referred to as “carbon material”), examples include carbon black and carbon nanotube.

Examples of carbon black include ketjen black, ketjen black EC, channel black, oil furnace black, vulcan, furnace black, thermal black, acetylene black, lamp black, graphitized black, and oxide black, and, in view of excellent electrical conductivity, preferred are acetylene black, ketjen black, and ketjen black EC, and more preferred are ketjen black and ketjen black EC. Carbon black may be may be used a single kind alone or may be used in combination of two or more kinds. Carbon black which has been surface-treated may be used.

Examples of carbon nanotubes include single-walled nanotubes and multi-walled carbon nanotubes, which are obtained by, for example, a vapor phase growth method, a catalytic vapor phase growth method, a catalytic chemical vapor deposition method, a chemical vapor deposition method, a super-growth method, a catalytic carbon deposition method, an arc discharge method, or a laser evaporation method, and these carbon nanotubes can be in an arbitrary form, such as a needle-like form, a coiled form, or a tubular form. The tube of the carbon nanotube has a shape of a cylinder into which a carbon hexagonal plane of graphite is rolled, and examples of such carbon nanotubes include a multi-walled carbon nanotube made of three or more rolled layers of graphite plane, a single-walled carbon nanotube (SWNT) made of a single rolled layer of graphite plane, a double-walled carbon nanotube (DWNT) made of two rolled layers of graphite plane, and a vapor growth carbon fiber (VGCF, registered trademark, manufactured by Showa Denko K.K.). Specifically, there can be mentioned TC series, such as TC-2010, TC-2020, TC-3210L, and TC-1210LN (manufactured by Toda Kogyo Corp.), Super-growth method CNT (manufactured by New Energy and Industrial Technology Development Organization), eDIPS-CNT (manufactured by New Energy and Industrial Technology Development Organization), SWNT series (trade name; manufactured by Meijo Nano Carbon Co., Ltd.), VGCF (registered trademark) series, such as VGCF, VGCF-H, and VGCF-X (registered trademark; manufactured by Showa Denko K.K.), FloTube series (trade name; manufactured by CNano Technology, Ltd.), AMC (trade name; manufactured by Ube Industries, Ltd.), NANOCYL NC7000 series (trade name; manufactured by Nanocyl S.A.), Baytubes (trade name; manufactured by Bayer AG), GRAPHISTRENGTH (trade name; manufactured by Arkema K.K.), MWNT7 (trade name; manufactured by Hodogaya Chemical Co., Ltd.), and Hyperion CNT (trade name; manufactured by Hypeprion Catalysis International). Preferred are TC series, such as TC-2010, TC-2020, TC-3210L, and TC-1210LN, and VGCF (registered trademark) series, such as VGCF, VGCF-H, and VGCF-X.

Carbon nanotube may be used a single kind alone or may be used in combination of two or more kinds. Carbon nanotube which has been surface-treated may be used. Further, carbon black and carbon nanotube may be used in combination.

The carbon material having electrical conductivity is especially preferably at least one kind selected from the group consisting of ketjen black, ketjen black EC, and carbon nanotube.

The carbon material having electrical conductivity preferably has at least one substituent selected from the group consisting of a hydroxyl group, a carboxyl group, a carbonyl group, a formyl group, a sulfonic acid group, an oxysulfonic acid group, a carboxylic acid anhydride structure, a chromene structure, a lactone structure, an ester structure, and an ether structure, more preferably has at least one substituent selected from the group consisting of a hydroxyl group, a carboxyl group, a formyl group, a carboxylic acid anhydride structure, a lactone structure, an ester structure, and an ether structure, further preferably has at least one substituent selected from the group consisting of a hydroxyl group, a lactone structure, an ester structure, and an ether structure.

<<Method for Producing the Carbon-Based Calcined Material>>

The method for producing the carbon-based calcined material of the present invention is a method for producing a carbon-based calcined material of a mixture of an aromatic compound having a phenolic hydroxyl group and a carbon material having electrical conductivity, wherein the method comprises the step of obtaining a mixture of a fused liquid or organic solvent solution of an aromatic compound having a phenolic hydroxyl group and a carbon material having electrical conductivity.

When the aromatic compound having a phenolic hydroxyl group has a melting point lower than the calcination temperature and is not decomposed at the calcination temperature, the method for producing the carbon-based calcined material may comprise both the step of contacting a fused liquid of the aromatic compound having a phenolic hydroxyl group with a carbon material having electrical conductivity and the step of contacting an organic solvent solution of the aromatic compound having a phenolic hydroxyl group with a carbon material having electrical conductivity.

In the method for producing the carbon-based calcined material, by virtue of having such a step, the aromatic compound having a phenolic hydroxyl group in the state of a fused liquid or an organic solvent solution is in contact with the carbon material before being calcined at the calcination temperature. This state is considered that the aromatic compound having a phenolic hydroxyl group contacts with the carbon material as a level of molecule, causing an interaction between the aromatic compound having a phenolic hydroxyl group and the carbon material.

The method for producing the carbon-based calcined material is preferably the following Method for producing 1 or Method for producing 2.

<Method for Producing 1>

A method for producing a carbon-based calcined material of a mixture of an aromatic compound having a phenolic hydroxyl group and a carbon material having electrical conductivity, wherein the method comprises the steps of:

(step 1) obtaining a mixture of an aromatic compound having a phenolic hydroxyl group and a carbon material having electrical conductivity, and

(step 2) calcining the mixture obtained in the step 1 at a temperature which is the melting point of the aromatic compound having a phenolic hydroxyl group or higher.

<Method for Producing 2>

A method for producing a carbon-based calcined material of a mixture of an aromatic compound having a phenolic hydroxyl group and a carbon material having electrical conductivity, wherein the method comprises the steps of:

(step 1) obtaining a mixture of an organic solvent solution of an aromatic compound having a phenolic hydroxyl group and a carbon material having electrical conductivity, and

(step 2) calcining the mixture obtained in the step 1 at a temperature in the range of from 150 to 600° C.

In the step of obtaining a mixture of a fused liquid of an aromatic compound having a phenolic hydroxyl group and a carbon material having electrical conductivity, there is only a need to expose the aromatic compound having a phenolic hydroxyl group to a temperature of the melting point or higher, and therefore, in Methods for producing 1 and 2, this step may be present between step 1 and step 2 as a temperature increase step for calcination, or may be conducted in step 2.

The step of obtaining a mixture of an organic solvent solution of an aromatic compound having a phenolic hydroxyl group and a carbon material having electrical conductivity corresponds to step 1 in Method for producing 2.

When the aromatic compound having a phenolic hydroxyl group has a melting point lower than the calcination temperature and is not decomposed at the calcination temperature, the method preferably has the step of obtaining a mixture of a fused liquid of the aromatic compound having a phenolic hydroxyl group and a carbon material having electrical conductivity, and any of Method for producing 1 and Method for producing 2 is preferably selected, and Method for producing 1 is more preferably selected.

When the aromatic compound having a phenolic hydroxyl group has a high melting point of, for example, 300° C. or higher, or has a melting point higher than the calcination temperature, or has no melting point, the method preferably has the step of obtaining a mixture of an organic solvent solution of the aromatic compound having a phenolic hydroxyl group and a carbon material having electrical conductivity, and Method for producing 2 is preferably selected.

(1) Method for Producing 1

In step 1 for Method for producing 1, the mass ratio of the aromatic compound having a phenolic hydroxyl group and the carbon material having electrical conductivity is preferably 0.1:1 to 5:1, more preferably 0.2:1 to 2:1, further preferably 0.5:1 to 1:1. The mass ratio is preferably in the above range from the viewpoint of obtaining excellent electricity generation properties without sacrificing the electrical conductivity of the carbon material having electrical conductivity.

In Method for producing 1, with respect to the mixing method for step 1, a general mixing method can be employed, and examples include a mixing method using, for example, a shaker mixer, a Lödige mixer, a Julia mixer, or a twin-cylinder mixer.

In Method for producing 1, the calcination temperature for step 2 is preferably a temperature which is the melting point of the aromatic compound having a phenolic hydroxyl group or higher, and which is lower than a temperature at which the aromatic compound having a phenolic hydroxyl group is decomposed, more preferably 150 to 600° C., further preferably 180 to 500° C., most preferably 200 to 450° C. When the calcination temperature is in the above range, a reaction of the aromatic compound having a phenolic hydroxyl group and the carbon material having electrical conductivity satisfactorily proceeds.

The calcination is conducted at the calcination temperature preferably for 1 to 10 hours, more preferably for 1 to 5 hours. The calcination is preferably conducted in an inert gas. Examples of inert gases include nitrogen and argon.

(2) Method for Producing 2

In step 1 for Method for producing 2, the mass ratio of the aromatic compound having a phenolic hydroxyl group in the organic solvent solution and the carbon material having electrical conductivity is preferably 0.1:1 to 5:1, more preferably 0.2:1 to 2:1, further preferably 0.5:1 to 1:1. The mass ratio is preferably in the above range from the viewpoint of obtaining excellent electricity generation properties without sacrificing the electrical conductivity of the carbon material having electrical conductivity.

In Method for producing 2, with respect to the mixing method for step 1, a general mixing method can be employed, and examples include a mixing method using, for example, a shaker mixer, a Lödige mixer, a Julia mixer, or a twin-cylinder mixer.

With respect to the organic solvent, any organic solvent can be used as long as the solvent can dissolve therein the aromatic compound having a phenolic hydroxyl group, and, from the viewpoint of practically having a solubility of the aromatic compound therein of 0.1% by mass or more, preferably 0.5% by mass or more, and of easy removal of the solvent by drying, an organic solvent having a boiling point of 250° C. or lower is preferred. Examples of such organic solvents include organic solvents, e.g., ethers, such as tetrahydrofuran, diethyl ether, and 1,2-dimethoxyethane; halogenated hydrocarbons, such as methylene chloride, chloroform, and 1,2-dichloroethane; amides, such as N,N-dimethylformamide, N,N-dimethylacetamide, and N-methyl-2-pyrrolidone; ketones, such as acetone, methyl ethyl ketone, methyl isobutyl ketone, and cyclohexanone; alcohols, such as methanol, ethanol, isopropanol, n-propanol, isobutanol, and n-butanol; aliphatic hydrocarbons, such as n-heptane, n-hexane, and cyclohexane; aromatic hydrocarbons, such as benzene, toluene, xylene, and ethylbenzene; glycol ethers, such as ethylene glycol monoethyl ether, ethylene glycol monobutyl ether, propylene glycol monomethyl ether (1-methoxy-2-propanol), and propylene glycol 1-monomethyl ether 2-acetate; and glycols, such as ethylene glycol and propylene glycol, and these solvents can be used a single kind alone or may be used in combination of two or more kinds. Of these solvents, from the viewpoint of the compatibility with the aromatic compound having a phenolic hydroxyl group, preferred are alcohols, glycol ethers, and glycols.

With respect to the organic solvent, it is preferred that the organic solvent is removed by providing the step for drying the organic solvent after step 1 and before calcination in step 2. For example, for obtaining a homogeneous mixture and for drying the organic solvent, the contents placed in a container, such as a crucible, are dried while heating and stirring. By performing heating and stirring, even when all the aromatic compound having a phenolic hydroxyl group is not dissolved at room temperature, the remaining insoluble compound can be dissolved in the organic solvent by heating and stirring. The drying temperature can be a temperature which is the boiling point of the organic solvent or higher, and which is lower than a temperature at which the aromatic compound having a phenolic hydroxyl group is fused or decomposed.

In Method for producing 2, the calcination temperature for step 2 is more preferably 150 to 600° C., further preferably 180 to 500° C., most preferably 200 to 450° C. When the calcination temperature is in the above range, a reaction of the aromatic compound having a phenolic hydroxyl group and the carbon material having electrical conductivity satisfactorily proceeds, and further it is possible to prevent decomposition of the aromatic compound having a phenolic hydroxyl group.

The calcination is conducted at the calcination temperature preferably for 1 to 10 hours, more preferably for 1 to 5 hours. The calcination is preferably conducted in an inert gas. Examples of inert gases include nitrogen and argon.

<<Complex of the Carbon-Based Calcined Material and a Rare Earth Metal Ion, in which the Rare Earth Metal Ion and the Substituent of the Carbon-Based Calcined Material Form a Complex>>

The carbon-based calcined material of the present invention provides a complex of the carbon-based calcined material and a rare earth metal ion, wherein the rare earth metal ion and the substituent of the carbon-based calcined material form a complex.

In the complex of the carbon-based calcined material and a rare earth metal ion, with respect to the metal fused of the rare earth metal ion, examples include scandium, yttrium, lanthanum, cerium, praseodymium, neodymium, promethium, samarium, europium, gadolinium, terbium, dysprosium, holmium, erbium, thulium, ytterbium, and lutetium, and preferred are scandium, yttrium, lanthanum, cerium, praseodymium, neodymium, samarium, europium, gadolinium, and ytterbium, and more preferred are scandium, yttrium, lanthanum, cerium, samarium, europium, and ytterbium. These may be used a single kind alone or may be used in combination of two or more kinds.

In the complex of the carbon-based calcined material and a rare earth metal ion, the substituent of the carbon-based calcined material and the rare earth metal ion form a complex.

Examples of complex structures of the substituent of the carbon-based calcined material and a rare earth metal ion include a complex structure of the substituent derived from the surface and carbon deficient portion of the carbon material having electrical conductivity and a rare earth metal ion, and a complex structure of a hydroxyl group derived from the aromatic compound having a phenolic hydroxyl group and a rare earth metal ion. Any one of the complex structures or both of the complex structures may be employed.

More specifically, the substituent of the calcined material is preferably at least one kind selected from the group consisting of a hydroxyl group, a carboxyl group, a carbonyl group, a formyl group, a sulfonic acid group, an oxysulfonic acid group, a carboxylic acid anhydride structure, a chromene structure, a lactone structure, an ester structure, and an ether structure, which are derived from the carbon material having electrical conductivity, and a hydroxyl group derived from the aromatic compound having a phenolic hydroxyl group.

Examples of complex structures of the substituent derived from the surface and carbon deficient portion of the carbon material having electrical conductivity and a rare earth metal ion include a linkage of a monovalent anion formally deprotonated from at least one substituent selected from the group consisting of a hydroxyl group, a carboxyl group, a carbonyl group, a formyl group, a sulfonic acid group, an oxysulfonic acid group, a carboxylic acid anhydride structure, a chromene structure, a lactone structure, an ester structure, and an ether structure, which are derived from the carbon material, and a rare earth metal ion. It is preferred that a rare earth metal ion and the substituent of the surface and carbon deficient portion of the carbon material form a complex structure through —O—. For the reason of achieving the improved stability, more preferred is a structure in which a rare earth metal ion and the surface of the carbon material form one or more cyclic structures, i.e., chelate ring through —O—.

Examples of complex structures of a hydroxyl group derived from the aromatic compound having a phenolic hydroxyl group and a rare earth metal ion include a complex structure of a partial structure represented by the formula (A) below, which is formed from the aromatic compound having a phenolic hydroxyl group by calcination, and a rare earth metal ion, e.g., a partial structure represented by the formula (B) below. It is preferred that at least part of the aromatic compound having a phenolic hydroxyl group is contained as a terpolymer represented by the formula (A) below in the carbon-based calcined material.

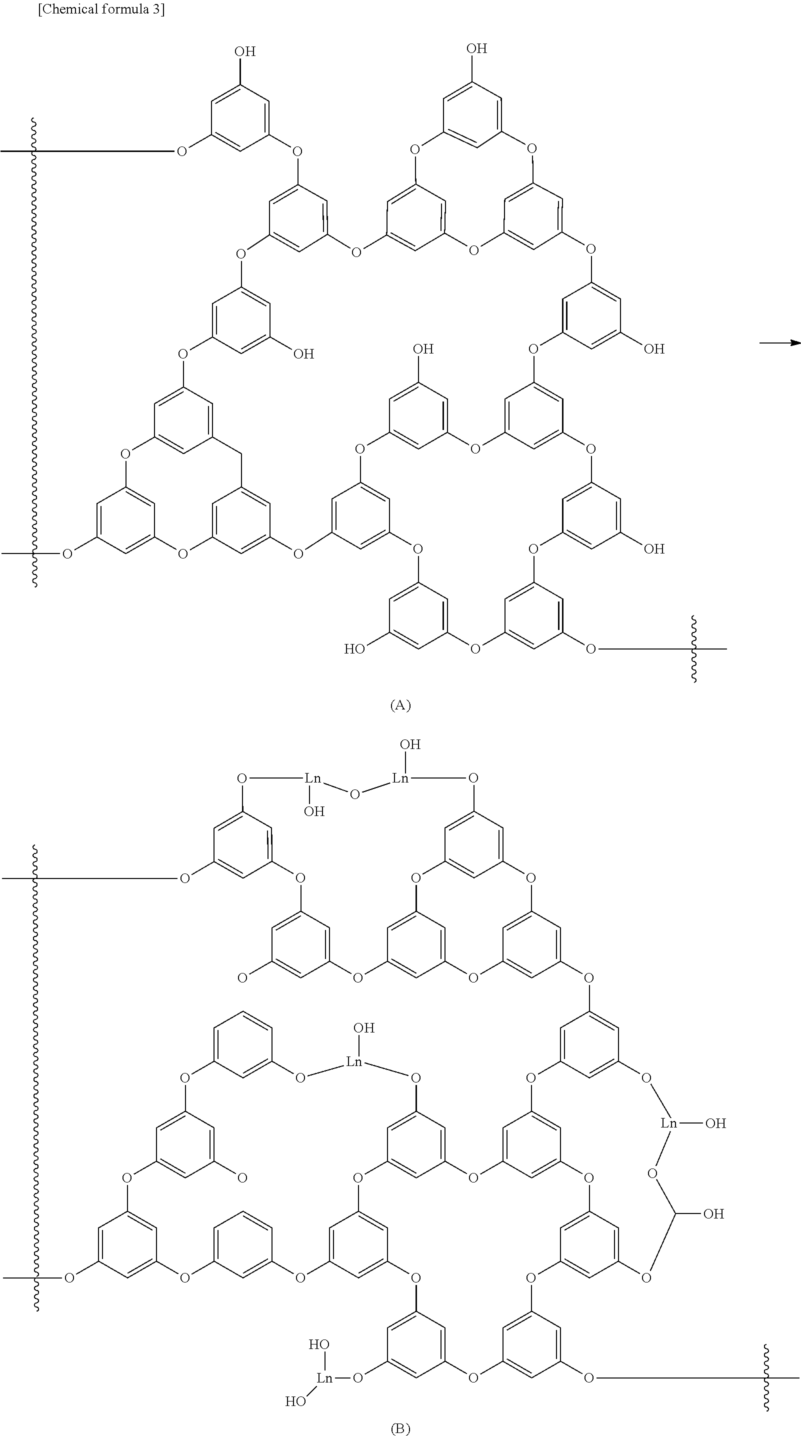

With respect to the method for producing the complex of the carbon-based calcined material and a rare earth metal ion, there can be mentioned the following Method for producing A and Method for producing B. From the viewpoint of the electricity generation properties, Method for producing B is preferred.

### <Method A for Producing the Complex of the Carbon-Based Calcined Material and a Rare Earth Metal Ion>

Method for producing A comprises the below-mentioned step 1A, preferably further comprises the below-mentioned step 2A.

The complex of the carbon-based calcined material and a rare earth metal ion, wherein the rare earth metal ion and the substituent of the carbon-based calcined material form a complex structure, can be produced by step 1A. From the viewpoint of the durability, it is preferred that, after step 1A, step 2A is conducted.

[Step 1A]

In step 1A, the carbon-based calcined material of the present invention and a rare earth metal compound are reacted with each other to obtain a complex of the carbon-based calcined material and a rare earth metal ion wherein the rare earth metal ion and the substituent of the carbon-based calcined material of the present invention form a complex.

In step 1A, with respect to the reaction of the carbon-based calcined material and the rare earth metal compound, the carbon-based calcined material and the rare earth metal compound are reacted in a solvent.

The substituent of the carbon-based calcined material used in the reaction in step 1A is preferably at least one kind selected from the group consisting of a hydroxyl group, a carboxyl group, a carbonyl group, a formyl group, a sulfonic acid group, an oxysulfonic acid group, a carboxylic acid anhydride structure, a chromene structure, a lactone structure, an ester structure, and an ether structure, more preferably has at least one substituent selected from the group consisting of a hydroxyl group, a carboxyl group, a formyl group, a carboxylic acid anhydride structure, a lactone structure, an ester structure, and an ether structure, further preferably at least one kind selected from the group consisting of a hydroxyl group, a lactone structure, an ester structure, and an ether structure.

With respect to the rare earth metal compound used in step 1A, examples include CeBr₃, CeCl₃·7H₂O, CeF₃, CeF₄, CeI₃,

DyBr₃, DyBr₃·xH₂O, DyCl₃, DyCl₃·6H₂O, DyF₃, DyI₃,
ErBr₃·xH₂O, ErCl₃, ErCl₃·6H₂O, ErF₃, ErI₃,
EuBr₃·xH₂O, EuCl₂, EuCl₃, EuCl₃·6H₂O, EuF₃, EuI₂,
GdBr₃, GdCl₃, GdCl₃·6H₂O, GdCl₃·xH₂O, GdF₃, GdI₃,
HoBr₃, HoBr₃·xH₂O, HoCl₃, HoCl₃·6H₂O, HoF₃,
LaBr₃·xH₂O, LaCl₃·7H₂O, LaCl₃·xH₂O, LaF₃, LaI₃,
LuBr₃, LuCl₃, LuCl₃·6H₂O, LuF₃, LuI₃,
NdBr₃, NdCl₃, NdCl₃·6H₂O, NdF₃, NdI₂, NdI₃,
PrBr₃, PrBr₃·xH₂O, PrCl₃,
SmBr₃, SmCl₃, SmCl₃·6H₂O, SmI₂, SmI₃,
ScBr₃, ScCl₃, ScCl₃·6H₂O, ScF₃, ScI₃,
TbBr₃, TbCl₃, TbCl₃·6H₂O, TbF₃, TbI₃,
TmBr₃, TmCl₃, TmCl₃·6H₂O, TmF₃,
YbBr₃, YbBr₃·xH₂O, YbCl₃, YbCl₃·6H₂O, YbF₃, YbI₂,
YCl₃, YCl₃·6H₂O, YF₃, YI₃,
Ce(NH₄)₂(NO₃)₆, Ce(NO₃)₃·6H₂O, Dy(NH₄)₂(NO₃)₆, Er(NO₃)₃·5H₂O, Er(NO₃)₃·xH₂O, Gd(NO₃)₃·6H₂O, Ho(NO₃)₃·5H₂O, La(NO₃)₃·6H₂O, La(NO₃)₃·xH₂O, Lu(NO₃)₃·xH₂O, Nd(NO₃)₃·6H₂O, Pr(NO₃)₃·6H₂O, Sm(NO₃)₃·6H₂O, Tb(NO₃)₃·5H₂O, Tb(NO₃)₃·6H₂O, Yb(NO₃)₃·5H₂O,
Ce(CH₃CO₂)₃·xH₂O, Eu(CH₃CO₂)₃·xH₂O,
Gd(CH₃CO₂)₃·xH₂O, La(CH₃CO₂)₃·xH₂O,
Tb(CH₃CO₂)₃·xH₂O, Yb(C₂H₃O₂)₃·4H₂O,
CeO₂, Dy₂O₃, Er₂O₃, Eu₂O₃, Gd₂O₃, HO₂O₃, La₂O₃, Lu₂O₃, Nd₂O₃,
Pr₂O₃, Pr₆O₁₁, Sm₂O₃, Sc₂O₃, Tb₂O₃, Tb₄O₇, Tm₂O₃, Yb₂O₃, Y₂O₃,
AlCeO₃, (CeO₂)(ZrO₂), rare earth metal alkoxide compounds, and rare earth metal acetylacetonato compounds. These may be used a single kind alone or may be used in combination of two or more kinds.

Specific examples of rare earth metal alkoxide compounds include rare earth metal triisopropoxides. Specific examples of rare earth metal triisopropoxides include scandium triisopropoxide, yttrium triisopropoxide, lanthanum triisopropoxide, cerium triisopropoxide, praseodymium triisopropoxide, neodymium triisopropoxide, promethium triisopropoxide, samarium triisopropoxide, europium triisopropoxide, gadolinium triisopropoxide, terbium triisopropoxide, dysprosium triisopropoxide, holmium triisopropoxide, erbium triisopropoxide, thulium triisopropoxide, ytterbium triisopropoxide, and lutetium triisopropoxide.

Specific examples of rare earth metal acetylacetonato compounds include tris(acetylacetonato)scandium(III), tris(acetylacetonato)yttrium n-hydrate, tris(acetylacetonato)lanthanum(III) hydrate, tris(acetylacetonato)cerium(III), tris(acetylacetonato)neodymium(III), tris(acetylacetonato)promethium(III), tris(acetylacetonato)samarium(III), tris(acetylacetonato)europium(III), tris(acetylacetonato)gadolinium(III), tris(acetylacetonato)terbium(III), tris(acetylacetonato)dysprosium(III), tris(acetylacetonato)holmium(III), tris(acetylacetonato)erbium(III), tans(acetylacetonato)thulium(III), tris(acetylacetonato)ytterbium(III), and tris(acetylacetonato)lutetium(III), and these compounds may be in the form of a hydrate.

The rare earth metal compound used in step 1A is preferably at least one kind selected from the group consisting of CeBr₃, CeCl₃·7H₂O, CeF₃, CeF₄, CeI₃, EuBr₃·xH₂O, EuCl₂, EuCl₃, EuCl₃·6H₂O, EuF₃, EuI₂, NdBr₃, NdCl₃, NdCl₃·6H₂O, NdF₃, NdI₂, NdI₃, SmBr₃, SmCl₃, SmCl₃·6H₂O, SmI₂, SmI₃, Ce(NH₄)₂(NO₃)₆, Ce(NO₃)₃·6H₂O, Nd(NO₃)₃·6H₂O, Ce(CH₃CO₂)₃·xH₂O, Ce(C₅H₇O₂)₃·xH₂O, Eu(CH₃CO₂)₃·xH₂O, CeO₂, Eu₂O₃, Nd₂O₃, Sm₂O₃, Sc₂O₃, (CeO₂)(ZrO₂), and samarium triisopropoxide, more preferably at least one kind selected from the group consisting of CeBr₃, CeCl₃·7H₂O, CeF₃, CeF₄, CeI₃, EuI₂, NdI₂, NdI₃, SmBr₃, SmCl₃, SmCl₃·6H₂O, SmI₂, SmI₃, Ce(NH₄)₂(NO₃)₆, Ce(NO₃)₃·6H₂O, Ce(CH₃CO₂)₃·xH₂O, Ce(C₅H₇O₂)₃·xH₂O, Sm₂O₃, and samarium triisopropoxide.

Step 1A can be conducted in the presence of a base, such as sodium hydride, lithium hydride, sodium hydroxide, 1,8-diazabicyclo-5,4,0-undec-7-ene (DBU), trimethylamine, triethylamine, tripropylamine, N-ethylmethylbutylamine, tributylamine, N,N-dimethylbenzylamine, N,N-diethylbenzylamine, or tribenzylamine. Of these, sodium hydride and lithium hydride are preferred.

With respect to the solvent used in step 1A, any nonaqueous solvent can be used as long as the solvent can disperse therein the carbon-based calcined material and can dissolve or disperse therein the rare earth metal compound, and examples of such solvents include cyclohexane, benzene, toluene, nitrobenzene, carbon tetrachloride, diethyl ether, tetrahydrofuran, isoxazole, 1,4-dioxane, cyclopentylmethyl ether, acetone, acetonitrile, nitromethane, dimethyl sulfoxide, N,N-dimethylformamide, sulfolane, 1,3-propane sultone, and 1,4-butane sultone. 1,3-Propane sultone is an object to be reacted but can serve as a solvent. Preferred are toluene, tetrahydrofuran, dimethyl sulfoxide, N,N-dimethylformamide, and 1,3-propane sultone, and more preferred is tetrahydrofuran.

The reaction temperature in step 1A is preferably −10 to 200° C., more preferably 10 to 160° C., further preferably 15 to 140° C.

The reaction time in step 1A is preferably 1 to 500 hours, more preferably 2 to 300 hours, further preferably 5 to 150 hours.

[Step 2A]

In step 2A, the complex of the carbon-based calcined material and the rare earth metal obtained in step TA is cleaned with an acid and water. In the complex obtained through step 2A, the reactive substituents and impurities are removed by cleaning before used in a fuel cell device, and hence a damage to a fuel cell device caused by decomposition products can be as small as possible, so that excellent durability is achieved.

With respect to the acid used in step 2A, for example, an inorganic acid, such as sulfuric acid, hydrochloric acid, nitric acid, sulfurous acid, nitrous acid, or phosphoric acid, or an organic acid, such as acetic acid, lactic acid, oxalic acid, citric acid, or formic acid, can be used, and, from the viewpoint of the fuel cell device, preferred is sulfuric acid which is unlikely to cause impurities to remain.

<Method for Producing B for Producing the Complex of the Carbon-Based Calcined Material and a Rare Earth Metal Ion>

Method for producing B comprises the below-mentioned step 1B, preferably further comprises the below-mentioned step 2B.

The complex of the carbon-based calcined material and a rare earth metal ion, wherein the rare earth metal ion and the substituent of the carbon-based calcined material form a complex structure, can be produced by step 1B. If necessary, after step 1B, step 2B may be conducted.

[Step 1B]

In step 1B, a mixture of the carbon-based calcined material of the present invention and a rare earth metal compound is calcined to obtain a complex of the carbon-based calcined material and a rare earth metal ion wherein the rare earth metal ion and the substituent of the carbon-based calcined material form a complex structure.

The substituent of the carbon-based calcined material used in the reaction in step 1B is preferably at least one kind selected from the group consisting of a hydroxyl group, a carboxyl group, a carbonyl group, a formyl group, a sulfonic acid group, an oxysulfonic acid group, a carboxylic acid anhydride structure, a chromene structure, a lactone structure, an ester structure, and an ether structure, more preferably has at least one substituent selected from the group consisting of a hydroxyl group, a carboxyl group, a formyl group, a carboxylic acid anhydride structure, a lactone structure, and an ester structure, further preferably at least one kind selected from the group consisting of a hydroxyl group, a lactone structure, an ester structure, and an ether structure.

As examples of the rare earth metal compounds used in step 1B, there can be mentioned compounds similar to the compounds mentioned above in connection with step 1A.

The rare earth metal compound used in step 1B is preferably at least one kind selected from the group consisting of Ce(CH₃CO₂)₃·xH₂O, Ce(C₅H₇O₂)₃·xH₂O,

Eu(CH₃CO₂)₃·xH₂O,
Gd(CH₃CO₂)₃·xH₂O, Gd(C₅H₇O₂)₃·xH₂O, La(CH₃CO₂)₃·xH₂O, La(C₅H₇O₂)₃·xH₂O,
Tb(CH₃CO₂)₃·xH₂O, Yb(C₂H₃O₂)₃·4H₂O,
cerium triisopropoxide, samarium triisopropoxide,
tris(acetylacetonato)cerium(III), and tris(acetylacetonato)samarium(III),
more preferably at least one kind selected from the group consisting of Ce(CH₃CO₂)₃·xH₂O, Ce(C₅H₇O₂)₃·xH₂O, samarium triisopropoxide, tris(acetylacetonato)cerium(III), and tris(acetylacetonato)samarium(III).

The calcination temperature in step 1B is preferably 100 to 1,000° C., more preferably 150 to 600° C., further preferably 200 to 500° C.

The calcination time in step 1B is preferably 1 to 500 hours, more preferably 2 to 300 hours, further preferably 5 to 150 hours.

With respect to the atmosphere for the calcination in step 1B, the calcination can be conducted under atmospheric conditions or in an inert gas, and examples of atmospheric conditions include air, and examples of inert gases include nitrogen and argon. The atmosphere for the calcination is preferably an inert gas, and nitrogen is preferred as an inert gas.

[Step 2B]

Step 2B is similar to [Step 2A].

<Use of the Carbon-Based Calcined Material and Complex>

The carbon-based calcined material and the complex can be used in an electrolyte and a catalyst carrier in a catalyst layer for a polymer electrolyte fuel cell and in a polymer electrolyte membrane, and can improve the electricity generation properties of a fuel cell. Further, the carbon-based calcined material and the complex can be used in a catalyst layer as a material for an electrocatalyst for, for example, water electrolysis, and can improve the power generating water electrolytic bath of a fuel cell in the performance of voltage output and fuel consumption. An example of the use in a fuel cell is described below.

<<Polymer Electrolyte Fuel Cell>>

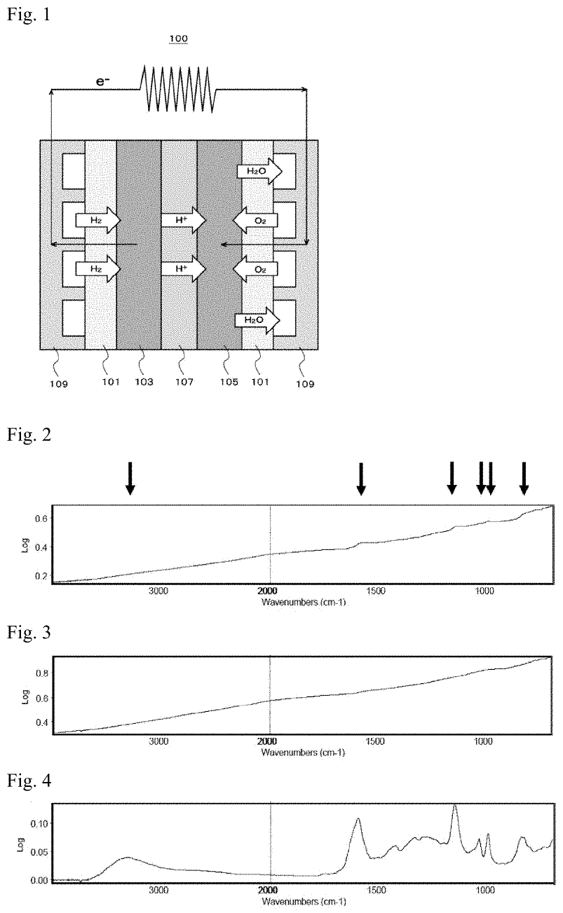

FIG. 1 is a cross-sectional view diagrammatically showing the construction of a polymer electrolyte fuel cell (hereinafter, frequently referred to as “fuel cell”). Polymer electrolyte fuel cell 100 has anode catalyst layer 103, cathode catalyst layer 105, and polymer electrolyte membrane 107 disposed between the catalyst layers, and each catalyst layer has gas diffusion layer (hereinafter, abbreviated to “GDL”) 101 as an outside layer. This construction is called a membrane electrode assembly (hereinafter, abbreviated to “MEA”). A fuel cell generally has the MEA disposed between separators 109.

At least one of anode catalyst layer 103 and cathode catalyst layer 105 contains the carbon-based calcined material and/or the complex. Further, polymer electrolyte membrane 107 also may contain the carbon-based calcined material and/or the complex. From the viewpoint of the suppression of overvoltage increase during the high current driving, it is preferred that the carbon-based calcined material and/or the complex is used in at least cathode catalyst layer 105.

The carbon-based calcined material and the complex have proton conductive properties, electronic conductive properties, water transport, and gas permeability, and further have a function to have supported thereon a catalyst by virtue of the structure thereof. Therefore, the carbon-based calcined material and the complex can be used in a catalyst layer for a fuel cell as a catalyst carrier, an electrolyte, or both of them, and as an electrolyte in a polymer electrolyte membrane.

With respect to the main function of the carbon-based calcined material and the complex, it is considered that, in addition to the electronic conductive properties and specific surface area inherent of the carbon material which is a base material of the carbon-based calcined material and the complex, the carbon-based calcined material and the complex have a proton receiving and giving effect due to the phenolic hydroxyl group imparted by the aromatic compound having a phenolic hydroxyl group after calcination, a function of suppressing aggregation of the carbon material after calcination and improving the dispersion stability of a catalyst ink due to such an effect, a function of improving the supporting ability for solid catalyst, and a function of water transport due to adsorption and desorption of water, and further the pores of the carbon material itself have a function of diffusion of gas.

Anode catalyst layer 103 and cathode catalyst layer 105 are obtained by preparing a composition comprising at least one kind selected from the group consisting of the carbon-based calcined material and the complex and a metal catalyst as a catalyst ink, and then applying the catalyst ink onto an intended substrate and drying the applied ink. That is, anode catalyst layer 103 and cathode catalyst layer 105 comprise a composition comprising a metal catalyst and at least one kind selected from the group consisting of the carbon-based calcined material and the complex.

It is preferred that the carbon-based calcined material and the complex are a kind of electrolyte and a kind of catalyst carrier. When the carbon-based calcined material and the complex serve as both an electrolyte and a catalyst carrier, the catalyst carrier that conventionally has not have proton conductive properties has proton conductive properties, and is expected to improve, e.g., the electric properties of a fuel cell.

The catalyst supported on a catalyst carrier is referred to as electrocatalyst. In the present specification, anode catalyst layer 103 and cathode catalyst layer 105 are frequently referred to simply as “catalyst layer”.

With respect to the metal catalyst contained in the catalyst ink, there is no particular limitation and a known metal catalyst can be used. A main function of the metal catalyst used in anode catalyst layer 103 and cathode catalyst layer 105 is to cause an electrochemical reaction. Examples of metal catalysts include platinum-containing catalysts, such as platinum, an alloy of platinum and another metal, and a core/shell catalyst having a shell portion composed of platinum; and other metal catalysts. These may be used a single kind alone or may be used in combination of two or more kinds. Of these, in view of the catalytic activity, a platinum-containing catalyst is preferred. Examples of platinum-containing catalysts include platinum catalyst TEC10E50E (manufactured by Tanaka Kikinzoku Kogyo K.K.) which is a platinum catalyst using carbon black as a catalyst carrier.

In the alloy of platinum and another metal, with respect to the metal constituting the alloy, together with platinum, there is no particular limitation as long as the metal is other than platinum, and examples of such metals include boron, magnesium, aluminum, silicon, calcium, scandium, titanium, vanadium, chromium, manganese, iron, cobalt, nickel, copper, zinc, gallium, germanium, strontium, yttrium, zirconium, niobium, molybdenum, technetium, ruthenium, rhodium, palladium, silver, indium, tin, antimony, barium, hafnium, tantalum, tungsten, rhenium, osmium, iridium, gold, lead, bismuth, lanthanum, and cerium. These metals may be used a single kind alone or may be used in combination of two or more kinds.

The core/shell catalyst having a shell portion composed of platinum has a core portion composed of a metal other than platinum, and has a shell portion composed of platinum. With respect to the metal used in the core portion, there is no particular limitation as long as the metal is other than platinum, and examples of such metals include nickel, copper, palladium, silver, gold, iridium, titanium, iron, cobalt, ruthenium, osmium, chromium, molybdenum, and tungsten. These metals may be used a single kind alone or may be used in combination of two or more kinds.

A platinum-containing catalyst is preferably used as the catalyst, but the catalyst is not limited to the platinum-containing catalyst, and, as another metal catalyst, a noble metal, such as gold, silver, ruthenium, rhodium, palladium, osmium, or iridium, a base metal, such as iron, nickel, manganese, cobalt, chromium, copper, zinc, molybdenum, tungsten, germanium, or tin, an alloy of a noble metal and a base metal, or a compound, such as a metal oxide or a metal complex, can be employed. These catalysts may be used a single kind alone or may be used in combination of two or more kinds.

The composition used as a catalyst ink may contain, in addition to the metal catalyst and the carbon-based calcined material and/or the complex, a catalyst carrier other than the carbon-based calcined material and/or the complex, an electrolyte other than the carbon-based calcined material and/or the complex, a binder, and a solvent. Like the metal catalyst and the carbon-based calcined material and/or the complex, the components other than the solvent are contained in at least one of anode catalyst layer 103 and cathode catalyst layer 105.

Examples of catalyst carriers other than the carbon-based calcined material and/or the complex, which may be contained in the composition used as a catalyst ink, include carbon black, such as channel black, furnace black, and thermal black, and carbon materials, such as activated carbon obtained by subjecting various materials containing a carbon atom to carbonization for activation treatment, coke, natural graphite, artificial graphite, and graphitized carbon. These may be used a single kind alone or may be used in combination of two or more kinds. Of these, as the catalyst carrier other than the carbon-based calcined material and/or the complex, preferred is carbon black because it has high specific surface area and excellent electronic conductive properties. A main function of the catalyst carrier is to conduct electrons. Further examples of main functions of the catalyst carrier include transport of gas and water by virtue of pores of the catalyst carrier.

For suppressing lowering of the electronic conductive properties in the electrocatalyst, a binder for binding the catalyst carrier together can be used in the catalyst layer, and examples of binders include polytetrafluoroethylene (PTFE), polyvinylidene fluoride (PVDF), an ethylene-propylene-diene copolymer (EPDM), and fluorine sulfonic acid polymers, such as Nafion (registered trademark; manufactured by DuPont Inc.), Aquivion (registered trademark; manufactured by Solvay S.A.), Flemion (registered trademark; manufactured by AGC Inc.), and Aciplex (registered trademark; manufactured by Asahi Kasei Corporation). These may be used a single kind alone or may be used in combination of two or more kinds.

Examples of electrolytes other than the carbon-based calcined material and/or the complex, which may be contained in the composition used as a catalyst ink, include fluorine sulfonic acid polymers, such as Nafion (registered trademark; manufactured by DuPont Inc.), Aquivion (registered trademark; manufactured by Solvay S.A.), Flemion (registered trademark; manufactured by AGC Inc.), and Aciplex (registered trademark; manufactured by Asahi Kasei Corporation), hydrocarbon sulfonic acid polymers, and fluorine sulfonic acid polymer partially introduced-type hydrocarbon sulfonic acid polymers. These may be used a single kind alone or may be used in combination of two or more kinds.

With respect to the electrolyte other than the carbon-based calcined material and/or the complex, preferred are perfluorosulfonic acid polymers, such as Nafion (registered trademark; manufactured by DuPont Inc.), Aquivion (registered trademark; manufactured by Solvay S.A.), Flemion (registered trademark; manufactured by AGC Inc.), and Aciplex (registered trademark; manufactured by Asahi Kasei Corporation), and more preferred is Nafion (registered trademark; manufactured by DuPont Inc.). With respect to the electrolyte, the carbon-based calcined material and/or the complex can be individually used, or the carbon-based calcined material and/or the complex and the above-mentioned electrolyte can be used in combination. A main function of the electrolyte in the catalyst layer is to conduct protons, but, from the viewpoint of being further required to pass fuel gas and transport water simultaneously with the proton conduction, and from the viewpoint of the voltage properties in a high current region, the electrolyte in the composition used as a catalyst ink preferably contains the carbon-based calcined material and/or the complex and a perfluorosulfonic acid polymer, such as the above-mentioned Nafion. In the catalyst layer containing the carbon-based calcined material and/or the complex, tany material of a fluorine sulfonic acid polymer, a hydrocarbon sulfonic acid polymer, and a fluorine sulfonic acid polymer partially introduced-type hydrocarbon sulfonic acid polymer, which is the material for polymer electrolyte membrane, can be used as a material for the catalyst layer, and a fluorine sulfonic acid polymer and a fluorine sulfonic acid polymer partially introduced-type hydrocarbon sulfonic acid polymer are preferably used.

Examples of solvents used in the composition used as a catalyst ink include water, methanol, ethanol, 1-propanol, 2-propanol, 1-butanol, 2-butanol, isobutyl alcohol, tert-butyl alcohol, pentanol, dimethyl sulfoxide, and N,N-dimethylformamide. With respect to the solvent, preferred are water, methanol, ethanol, 1-propanol, 2-propanol, 1-butanol, 2-butanol, and isobutyl alcohol. Two or more of the above-mentioned solvents can be used in combination. From the viewpoint of suppressing reaggregation of the ink to facilitate application of the ink and further preventing the solvent from remaining in the catalyst layer, as the solvent used in the catalyst ink, water, ethanol, 1-propanol, and 2-propanol are more preferred.

The content of each component in the catalyst ink is appropriately controlled according to the purpose, but the content of the metal catalyst is preferably 14 to 44% by mass, more preferably 24 to 34% by mass, based on the mass of the solids (100% by mass) obtained by removing the solvent from the catalyst ink; the content of at least one kind selected from the group consisting of the carbon-based calcined material and the complex is preferably 1 to 25% by mass, more preferably 5 to 20% by mass, based on the mass of the solids (100% by mass); when another electrolyte is contained in the catalyst ink, the content of the electrolyte is preferably 20 to 45% by mass, more preferably 25 to 40% by mass, based on the mass of the solids (100% by mass); when another catalyst carrier is contained in the catalyst ink, the content of the catalyst carrier is preferably 20 to 55% by mass, more preferably 25 to 45% by mass, based on the mass of the solids (100% by mass); and, when a binder is contained in the catalyst ink, the content of the binder is preferably 0 to 5% by mass, more preferably 0 to 3% by mass, based on the mass of the solids (100% by mass). With respect to the component which is mentioned as both the electrolyte and the binder, the amount of the component incorporated is included in the content of the electrolyte.

The amount of the solvent used in the catalyst ink is preferably 70 to 99% by mass, more preferably 80 to 96% by mass, based on the mass of the catalyst ink (100% by mass).

Controlling the formulation of the catalyst ink enables an improvement of the function or performance, e.g., suppression of lowering of the electronic conductive properties, improvement of the proton conductive properties, improvement of the diffusion properties for gas, improvement of the efficiency of water transport, and improvement of the mechanical strength of the catalyst layer.

The method for forming catalyst layer 103 and catalyst layer 105 is described. The above-mentioned catalyst ink is prepared, and then the catalyst ink is applied onto an intended substrate and dried to form a catalyst layer. Examples of intended substrates include a polymer electrolyte membrane, a GDL, and a sheet formed from a fluororesin, and a catalyst layer can be formed by a known method. When the catalyst ink is applied to a sheet formed from a fluororesin, the applied catalyst layer is transferred to a polymer electrolyte. The sheet formed from a fluororesin is generally a sheet formed from polytetrafluoroethylene (PTFE).

Examples of the formulations of the catalyst ink include a formulation of the catalyst ink in which the metal catalyst is platinum, the catalyst carrier is carbon black, and the electrolyte is the carbon-based calcined material and/or the complex and Nafion (registered trademark; manufactured by DuPont Inc.), and a formulation of the catalyst ink in which the metal catalyst is platinum, the catalyst carrier is carbon black, and the electrolyte is the carbon-based calcined material and/or the complex. Further examples include a formulation of the catalyst ink in which the catalyst is platinum, the catalyst carrier is carbon black and the carbon-based calcined material and/or the complex or only the carbon-based calcined material and/or the complex, and the electrolyte is the carbon-based calcined material and/or the complex. A catalyst ink having the carbon-based calcined material and/or the complex as at least part of a catalyst carrier is produced by subjecting a catalyst ink containing the carbon-based calcined material and/or the complex and a metal catalyst to disintegration treatment, and thus a catalyst ink comprising the carbon-based calcined material and/or the complex having a metal catalyst supported is obtained.

Examples of the disintegration treatments include a dry disintegration treatment and a wet disintegration treatment. Examples of means for a dry disintegration treatment include a ball mill, a planetary mill, a pin mill, and a jet mill. Examples of means for a wet disintegration treatment include an ultrasonic homogenizer, an ultrasonic dispersion mixer, a bead mill, a sand grinder, a homogenizer, and a wet jet mill. Of these, preferred means for the disintegration treatment are a ball mill, a bead mill, an ultrasonic homogenizer, an ultrasonic dispersion mixer, and a homogenizer, and especially preferred are a bead mill, an ultrasonic homogenizer, and an ultrasonic dispersion mixer. With respect to the solvent used in the wet disintegration treatment, there is no particular limitation, but, for example, the solvent used in the catalyst ink can be used.

A membrane electrode assembly (MEA) is formed using the carbon-based calcined material and/or the complex when preparing the catalyst ink, and incorporated into a unit cell, making it possible to obtain electricity generation properties.

A ratio of the amount of the carbon-based calcined material and/or the complex used in the catalyst layer is determined by making a calculation using the formula below. In the calculation formula below, with respect to the mass of each of the electrocatalyst, carbon-based calcined material and/or complex, electrolyte, and binder, a mass of the solids remaining after removing the water and solvent was used in the calculation. Further, in the calculation formula below, the electrolyte and electrocatalyst do not contain the carbon-based calcined material and/or complex of the present invention.

Carbon-based calcined material and/or complex ratio (% by mass)=[Carbon-based calcined material and/or complex(mass)/{Total mass of catalyst layer (in terms of the mass of the solids contained in the catalyst layer)}]×100(% by mass)=[Carbon-based calcined material and/or complex(mass)/{Electrocatalyst(mass)+Electrolyte other than carbon-based calcined material and/or complex(mass)+Binder(mass)+Carbon-based calcined material and/or complex(mass)}]×100(% by mass)

The carbon-based calcined material and/or complex ratio is preferably 1 to 25%, more preferably 5 to 20%.

When the catalyst layer contains an electrolyte other than the carbon-based calcined material and complex, the mass ratio of the carbon-based calcined material and/or complex and the electrolyte other than the carbon-based calcined material and complex in the catalyst layer (carbon-based calcined material and/or complex:electrolyte other than the carbon-based calcined material and complex) is preferably 1:1 to 1:10, more preferably 10:12 to 1:5.

Examples of materials for polymer electrolyte membrane 107 include the carbon-based calcined material and/or the complex, fluorine sulfonic acid polymers, such as Nafion (registered trademark; manufactured by DuPont Inc.), Aquivion (registered trademark; manufactured by Solvay S.A.), Flemion (registered trademark; manufactured by AGC Inc.), and Aciplex (registered trademark; manufactured by Asahi Kasei Corporation), hydrocarbon sulfonic acid polymers, and fluorine sulfonic acid polymer partially introduced-type hydrocarbon sulfonic acid polymers.

From the viewpoint of the electrical conductivity, durability, and gas cross-leakage, polymer electrolyte membrane 107 preferably has a thickness of 10 to 100 μm, more preferably 20 to 60 μm.

With respect to gas diffusion layer 101, there is no particular limitation, but a porous material having electrical conductivity is preferably used, and examples of such materials include paper and nonwoven fabric each made of carbon, felt, and nonwoven fabric. Further, the GDL includes a material coated with a layer called a microporous layer (hereinafter, abbreviated to “MPL”) which is a coating layer comprised mainly of a water-repellent resin and a carbon material, and such a layer has been reported to achieve effective transport of water during electricity generation of a fuel cell, and a gas diffusion layer having the MPL can be used in the catalyst layer containing the carbon-based calcined material and/or the complex. In the electricity generation test in the present invention, water-repellent carbon paper which is a GDL having the MPL was used.

### EXAMPLES

Hereinbelow, the present invention will be described in more detail with reference to the following Synthesis Examples and Examples, which should not be construed as limiting the scope of the present invention. The analysis apparatus used in the Synthesis Examples and Examples and the conditions therefor are as described below.

In the Examples and Comparative Examples, IR measurement was conducted by a germanium ATR method, in which the angle of incidence is 30 degrees, using apparatus name: Nicolet 6700-Continiuum (manufactured by Thermo Fisher Scientific K.K.).

### Example 1: Production of Calcined Material (1

A mixture (2.09 g) obtained by mixing ketjen black EC (EC300J, manufactured by Lion Specialty Chemicals Co., Ltd.; 1.08 g) and phloroglucinol (melting point: 220° C.; manufactured by Tokyo Chemical Industry Co., Ltd.; 1.08 g) using a mortar was placed in an alumina crucible. The crucible was set in bench gas replacement furnace KDF-75 (manufactured by Denken-Highdental Co., Ltd.), and a nitrogen gas atmosphere was made using a nitrogen gas flow, and then the temperature was increased at a rate of 3C per minute, and calcination was conducted at a calcination temperature of 250° C. for 2 hours. After the calcination, the temperature was reduced to room temperature while maintaining the nitrogen gas atmosphere, obtaining a black carbon-based calcined material (1.91 g, which corresponds to 91% by mass, based on the mass of the charged raw materials (100% by mass)). The black calcined material was ground by an agate mortar and used as a sample for evaluation.

IR measurement was conducted by a germanium ATR method. FIG. 2 shows an IR measurement chart of calcined material (1).

For comparison, with respect to ketjen black EC (EC300J, manufactured by Lion Specialty Chemicals Co., Ltd.) which is a raw material, IR measurement was conducted. FIG. 3 shows an IR measurement chart of ketjen black EC.

From a comparison made between FIG. 2 and FIG. 3, new peaks which are not seen in the IR measurement chart of ketjen black EC were found in the IR measurement chart of FIG. 2. In FIG. 2, the new peaks were indicated by arrows.

### Example 2: Production of Calcined Material (2

Ketjen black EC (EC300J, manufactured by Lion Specialty Chemicals Co., Ltd.; 0.27 g) and 5.67 g of a solution obtained by dissolving phloroglucinol (manufactured by Tokyo Chemical Industry Co., Ltd.; 0.27 g) in 5.13 g of 1-methoxy-2-propanol were placed in an alumina crucible. The solvent was allowed to volatilize on a hot plate stirrer set at 120° C. while stirring the contents using a Teflon (registered trademark) stirrer. The temperature of the hot plate stirrer was increased finally to 150° C. to dry the contents. Then, the crucible was set in bench gas replacement furnace KDF-75 (manufactured by Denken-Highdental Co., Ltd.), and a nitrogen gas atmosphere was made using a nitrogen gas flow, and then the temperature was increased at a rate of 3C per minute, and calcination was conducted at 250° C. for 2 hours. After the calcination, the temperature was reduced to 100° C. or lower while maintaining the nitrogen gas atmosphere. The contents of the alumina crucible were a black carbon-based calcined material, and the amount of the calcined material was 0.450 g (which corresponds to 83% by mass, based on the mass of the charged raw materials (100% by mass)). The black calcined material was ground by an agate mortar and used as a sample for evaluation.

### Example 3: Production of Calcined Material (3

Ketjen black EC (EC300J, manufactured by Lion Specialty Chemicals Co., Ltd.; 0.27 g) and 13.77 g of a solution obtained by dissolving 2,3,6,7,10,11-hexahydroxytriphenylene (melting point: higher than 390° C.; manufactured by FUJIFILM Wako Pure Chemical Corporation, Ltd.; 0.27 g) in 13.23 g of 1-methoxy-2-propanol were placed in an alumina crucible. The solvent was allowed to volatilize on a hot plate stirrer set at 120° C. while stirring the contents using a Teflon stirrer. The temperature of the hot plate stirrer was increased finally to 160° C. to dry the contents. Then, the crucible was set in bench gas replacement furnace KDF-75 (manufactured by Denken-Highdental Co., Ltd.), and a nitrogen gas atmosphere was made using a nitrogen gas flow, and then the temperature was increased at a rate of 3C per minute, and calcination was conducted at 350° C. for 2 hours. After the calcination, the temperature was reduced to 100° C. or lower while maintaining the nitrogen gas atmosphere. The contents of the alumina crucible were a black carbon-based calcined material, and the amount of the calcined material was 0.478 g (which corresponds to 88% by mass, based on the mass of the charged raw materials (100% by mass)). The black calcined material was ground by an agate mortar and used as a sample for evaluation.

### Example 4: Production of Calcined Material (4

Ketjen black EC (EC300J, manufactured by Lion Specialty Chemicals Co., Ltd.; 0.27 g) and 13.77 g of a solution obtained by dissolving 2,3,6,7,10,11-hexahydroxytriphenylene (manufactured by FUJIFILM Wako Pure Chemical Corporation, Ltd.; 0.27 g) in 13.23 g of 1-methoxy-2-propanol were placed in an alumina crucible. The solvent was allowed to volatilize on a hot plate stirrer set at 120° C. while stirring the contents using a Teflon stirrer. The temperature of the hot plate stirrer was increased finally to 160° C. to dry the contents. Then, the crucible was set in bench gas replacement furnace KDF-75 (manufactured by Denken-Highdental Co., Ltd.), and a nitrogen gas atmosphere was made using a nitrogen gas flow, and then the temperature was increased at a rate of 3C per minute, and calcination was conducted at 400° C. for 2 hours. After the calcination, the temperature was reduced to 100° C. or lower while maintaining the nitrogen gas atmosphere. The contents of the alumina crucible were a black carbon-based calcined material, and the amount of the calcined material was 0.450 g (which corresponds to 83% by mass, based on the mass of the charged raw materials (100% by mass)). The black calcined material was ground by an agate mortar and used as a sample for evaluation.

### Example 5: Production of Calcined Material (5

Carbon nanotube (VGCF (registered trademark)-X, manufactured by Showa Denko K.K.; 0.305 g) and 14.70 g of a solution obtained by dissolving 2,3,6,7,10,11-hexahydroxytriphenylene (manufactured by FUJIFILM Wako Pure Chemical Corporation, Ltd.; 0.300 g) in 14.095 g of 1-methoxy-2-propanol were placed in an alumina crucible. The solvent was allowed to volatilize on a hot plate stirrer set at 120° C. while stirring the contents using a Teflon stirrer. The temperature of the hot plate stirrer was increased finally to 160° C. to dry the contents. Then, the crucible was set in bench gas replacement furnace KDF-75 (manufactured by Denken-Highdental Co., Ltd.), and a nitrogen gas atmosphere was made using a nitrogen gas flow, and then the temperature was increased at a rate of 3C per minute, and calcination was conducted at 400° C. for 2 hours. After the calcination, the temperature was reduced to 100° C. or lower while maintaining the nitrogen gas atmosphere. The contents of the alumina crucible were a black carbon-based calcined material, and the amount of the calcined material was 0.518 g (which corresponds to 86% by mass, based on the mass of the charged raw materials (100% by mass)). The black calcined material was ground by an agate mortar and used as a sample for evaluation.

### Comparative Example 1: Production of Calcined Material (6) by Calcining Only 2,3,6,7,10,11-Hexahydroxytriphenylene

Production was conducted by substantially the same method as in Example 1 except that only 2,3,6,7,10,11-hexahydroxytriphenylene (manufactured by Tokyo Chemical Industry Co., Ltd.; 0.21 g) was used as a raw material, and that the calcination temperature was set at 350° C. A black calcined material (0.18 g, which corresponds to 86% by mass, based on the mass of the charged raw material (100% by mass)) was obtained.

In the following Test Examples, an electricity generation test was conducted in accordance with the procedure described below.

### <Electricity Generation Test A for Fuel Cell>

The formed MEA was incorporated into a unit cell having an electrode area of 1 cm² (JARI standard cell, manufactured by FC Development Co., Ltd.), and then an electricity generation test for fuel cell was conducted. Using a fuel cell evaluation system (AutoPEM, manufactured by Toyo Corporation), evaluation was made at a temperature of 80° C. and at a relative humidity of 95% using a hydrogen gas flow at 1 L/minute and an air gas flow at 2 L/minute, and a current density and a voltage were measured using an electrochemical measurement system (SP-300, manufactured by Bio-Logic Science Instruments). Further, an open circuit voltage (hereinafter, abbreviated to “OCV”) was measured. The OCV is a potential in the state that a voltage or a current is not applied to the unit cell.

### Test Example 1 (Electricity Generation Test Using Calcined Material (1

A catalyst ink was prepared using an electrocatalyst which is platinum-supported carbon (manufactured by Tanaka Kikinzoku Kogyo K.K.; platinum content: 46.5% by mass; trade name: “TEC10E50E”), calcined material (1), a Nafion dispersion (manufactured by Wako Pure Chemical Industries, Ltd.; trade name: “5% Nafion Dispersion Solution DE520 CS type”), and 2-propanol (manufactured by Wako Pure Chemical Industries, Ltd.). The electrocatalyst, calcined material (1), Nafion dispersion, and 2-propanol were placed in a glass vial in this order, and the resultant dispersion was irradiated with ultrasonic waves at an oscillation power set High for 30 minutes using ultrasonic cleaner ASU-6, manufactured by AS ONE Corporation, preparing a catalyst ink.

The catalyst ink preparation conditions are described below.

Catalyst Ink Preparation Conditions:

Nafion ratio (% by mass)=[Nafion solids(mass)/{Electrocatalyst(mass)+Nafion solids(mass)+Calcined material(mass)}]×100(% by mass)

The catalyst ink was prepared so that the Nafion ratio became 29% by mass.

Calcined material ratio (% by mass)=[Calcined material(mass)/{Electrocatalyst(mass)+Nafion solids(mass)+Calcined material(mass)}]×100(% by mass)

The catalyst ink was prepared so that the calcined material ratio became 16% by mass. Specifically, when the mass of the electrocatalyst was 27.5 mg, a catalyst ink was prepared such that the amount of the Nafion dispersion was set to 294.8 mg, the amount of the calcined material was set to 8.0 mg, and the amount of 2-propanol was set to 1 mL. The Nafion dispersion in an amount of 294.8 mg corresponds to the dispersion containing 14.7 mg of the solids of Nafion.

Catalyst Ink Application Conditions (Preparation of Decal (Decalcomania)):

The catalyst ink was applied using a table having as a target a Teflon sheet having an area of 8 cm×8 cm and a thickness of 130 μm and using an applicator, and all the prepared catalyst ink was used so that the amount of the platinum per 1 cm² in the resultant catalyst layer became 0.2 mg, forming a decal having the catalyst layer on the Teflon sheet. The sheet having the decal was cut into a decal sheet having an area of 1 cm×1 cm. The coating weight of platinum in each of the anode and the cathode was found to be 0.2 mg as the difference between the mass of each decal and the mass after transfer.

Step of Forming an MEA:

A membrane electrode assembly (hereinafter, abbreviated to “MEA”) was formed from a polymer electrolyte membrane, a gas diffusion layer (hereinafter, abbreviated to “GDL”), and a decal using a catalyst ink. As a GDL, carbon paper having an MPL (manufactured by SGL Carbon Japan Co., Ltd.; trade name: “28BC”) was used.

A 5 cm×5 cm square cut out from Nafion 212 membrane (registered trademark; manufactured by DuPont Inc.; thickness: 50 μm) was set as a polymer electrolyte membrane which is a middle layer, and the decals (area: 1 cm×1 cm) having the catalyst layer on a Teflon sheet were individually stacked on both surfaces of the membrane, and then the resultant stacked material was subjected to hot press under conditions such that the upper and lower platen temperature was 134° C. (132° C. in Test Examples 1 and 6 to 13 and Comparative Test Example 4), the load was 0.6 kN, and the pressing time was 240 seconds (120 seconds in Test Examples 1 and 6 to 13 and Comparative Test Example 4), and the Teflon sheet was peeled off to form a catalyst coated membrane (hereinafter, abbreviated to “CCM”). The coating weight of platinum in each of the anode and the cathode was determined as the difference between the mass of the decal and the mass after transfer.

As a GDL, carbon paper (manufactured by SGL Carbon Japan Co., Ltd.; trade name: “28BC”; area: 1 cm×1 cm) was used, and disposed so that the MPL layer side of the GDL faced the polymer electrolyte membrane side, and stacked on both the anode side and the cathode side, and then the JARI standard cell was clamped up to 4 Nm by 1 Nm using a torque wrench, so that the GDL and the CCM were pressed.

Using the formed MEA, electricity generation test A for fuel cell was conducted. The results of the measurement of voltage and current density are shown in Table 1. The OCV was 0.954 V.

### Test Examples 2 to 5

An MEA was formed in substantially the same manner as in Test Example 1 except that, in the catalyst ink preparation, instead of calcined material (1), 8.0 mg of calcined material (2) was used in Test Example 2, 8.0 mg of calcined material (3) was used in Test Example 3, 8.0 mg of calcined material (4) was used in Test Example 4, or 8.0 mg of calcined material (5) was used in Test Example 5. Using the formed MEA, electricity generation test A for fuel cell was conducted. The results of the measurement of voltage and current density are shown in Table 1. The OCV in Test Example 2 was 0.967 V, the OCV in Test Example 3 was 0.980 V, the OCV in Test Example 4 was 0.983 V, and the OCV in Test Example 5 was 0.985 V.

### Comparative Test Examples 1 to 3

An MEA was formed in substantially the same manner as in Test Example 1 except that, in the catalyst ink preparation, instead of calcined material (1), 8.0 mg of calcined material (6) was used in Comparative Test Example 1, 8.0 mg of ketjen black EC was used in Comparative Test Example 2, or 8.0 mg of a physical mixture of calcined material (6) and ketjen black EC (EC300J, manufactured by Lion Specialty Chemicals Co., Ltd.) in the same mass was used in Comparative Test Example 3. Using the formed MEA, electricity generation test A for fuel cell was conducted. The results of the measurement of voltage and current density are shown in Table 1.

The OCV in Comparative Test Example 1 was 0.936 V, the OCV in Comparative Test Example 2 was 0.974 V, and the OCV in Comparative Test Example 3 was 0.955 V.

TABLE 1

| | Electricity generation test | | | | | | | |
|---|---|---|---|---|---|---|---|---|
| | | | | | | Comparative | Comparative | Comparative |
| | Test | Test | Test | Test | Test | Test | Test | Test |
| | Example 1 | Example 2 | Example 3 | Example 4 | Example 5 | Example 1 | Example 2 | Example 3 |
| Material | Calcined | Calcined | Calcined | Calcined | Calcined | Calcined | Ketjen black | Calcined |
| | material | material | material | material | material | material | EC | material |
| | (1) | (2) | (3) | (4) | (5) | (6) | | (6) + Ketjen |
| | | | | | | | | black EC |
| OCV(V) | 0.954 | 0.967 | 0.980 | 0.983 | 0.985 | 0.936 | 0.974 | 0.955 |
| Current density | | | | | | | | |
| (A/cm²) | Voltage (V) | | | | | | | |
| 0.30 | 0.77 | 0.85 | 0.75 | 0.76 | 0.75 | 0.60 | 0.62 | 0.65 |
| 0.50 | 0.73 | 0.71 | 0.70 | 0.71 | 0.70 | 0.48 | 0.54 | 0.57 |
| 0.80 | — | 0.64 | 0.62 | 0.64 | 0.53 | 0.30 | 0.40 | 0.48 |
| 1.00 | 0.65 | 0.59 | 0.56 | 0.59 | 0.58 | 0.15 | 0.29 | 0.41 |
| | | | | | | (0.966 A/cm²) | | |
| 1.30 | — | 0.49 | 0.46 | 0.50 | 0.50 | — | 0.16 | 0.31 |
| | | | | | | | (1.200 A/cm²) | |
| 1.50 | 0.57 | 0.42 | 0.36 | 0.42 | 0.44 | — | — | 0.23 |
| 1.80 | — | 0.19 | 0.17 | 0.18 | 0.30 | — | — | — |

The electricity generation properties had excellent results in Test Examples 1 to 5, as compared to the electricity generation properties in Comparative Test Examples 1 to 3 in which an electricity generation test for fuel cell was conducted under substantially the same conditions as in Test Example 1 except that the materials added were changed.

From a comparison between Test Examples 1 to 5 and Comparative Test Examples 1 and 2, it is found that, by using the calcined material of a combination of the aromatic compound having a phenolic hydroxyl group and the carbon material having electrical conductivity, there can be obtained more excellent electricity generation properties than those obtained when using the calcined material of the aromatic compound having a phenolic hydroxyl group alone and the carbon material having electrical conductivity alone.

From a comparison between Test Examples 1 to 5 and Comparative Test Example 3, it is found that, by using the calcined material of a combination of the aromatic compound having a phenolic hydroxyl group and the carbon material having electrical conductivity, there can be obtained more excellent electricity generation properties than those obtained when using a combination of the calcined material of the aromatic compound having a phenolic hydroxyl group and the carbon material having electrical conductivity.

From a comparison between Test Examples 1 to 4 and Test Example 5, it is found that, when using carbon nanotube as a carbon material having electrical conductivity, there can be obtained more excellent electricity generation properties at an increased current density than those obtained when using ketjen black EC.

From a comparison between Test Example 1 and Test Example 2, it is found that there was almost no difference in the electricity generation properties between the case where phloroglucinol having a melting point of 220° C. was mixed as such with the carbon material, followed by calcination, and the case where phloroglucinol was dissolved in a solvent and then mixed with the carbon material, followed by calcination.

From Test Examples 1 to 5 above, it is apparent that the fuel cell using the calcined material obtained by the method of the present invention has excellent electricity generation properties. The reason why a voltage of 0.3 V or more can be maintained in the present electricity generation test even when the current density is in the region of 1.5 (A/cm²) is presumed that the formed water well flows and diffusion of oxygen (air) as a fuel is improved, and it is considered that the catalyst layer is improved in the water transport and gas permeability. Further, it is considered that the calcined material of the present invention has a hydroxyl group and therefore the proton receiving and giving effect is improved.

### Comparative Example 2: Production of Calcined Material (7) by Calcining Only Phloroglucinol

Production was conducted by substantially the same method as in Example 1 except that only phloroglucinol (manufactured by Tokyo Chemical Industry Co., Ltd.; 2.0 g) was used as a raw material. A black calcined material (1.8 g, which corresponds to a recovery of 90%, based on the weight of the charged raw material (100%)) was obtained.

IR measurement was conducted by a germanium ATR method. FIG. 4 shows an IR measurement chart of calcined material (7).

### Example 6: Production of Calcined Material (8

Production was conducted by substantially the same method as in Example 1 except that a mixture (2.34 g) obtained by mixing ketjen black EC (EC300J, manufactured by Lion Specialty Chemicals Co., Ltd.; 0.60 g) and phloroglucinol (manufactured by Tokyo Chemical Industry Co., Ltd.; 1.80 g) using a mortar was used as a raw material. A black calcined material (1.91 g, which corresponds to a recovery of 82%, based on the weight of the charged raw materials (100%)) was obtained.

### Example 7: Production of Calcined Material (9

Production was conducted by substantially the same method as in Example 1 except that a mixture (2.29 g) obtained by mixing ketjen black EC (EC300J, manufactured by Lion Specialty Chemicals Co., Ltd.; 1.80 g) and phloroglucinol (manufactured by Tokyo Chemical Industry Co., Ltd.; 0.60 g) using a mortar was used as a raw material. A black calcined material (2.15 g, which corresponds to a recovery of 94%, based on the weight of the charged raw materials (100%)) was obtained.

### Example 8: Production of Calcined Material (10

Production was conducted by substantially the same method as in Example 1 except that a mixture (0.99 g) obtained by mixing ketjen black EC (EC300J, manufactured by Lion Specialty Chemicals Co., Ltd.; 1.00 g) and 2,3,6,7,10,11-hexahydroxytriphenylene (manufactured by FUJIFILM Wako Pure Chemical Corporation, Ltd.; 1.00 g) using a mortar was used as a raw material, and that the calcination temperature was set at 350° C. A black calcined material (0.87 g, which corresponds to a recovery of 88%, based on the weight of the charged raw materials (100%)) was obtained.

### Example 9: Production of Calcined Material (11

Production was conducted by substantially the same method as in Example 1 except that a mixture (0.41 g) obtained by mixing ketjen black EC (EC300J, manufactured by Lion Specialty Chemicals Co., Ltd.; 0.21 g) and 2,3,6,7,10,11-hexahydroxytriphenylene (manufactured by FUJIFILM Wako Pure Chemical Corporation, Ltd.; 0.21 g) using a mortar was used as a raw material, and that the calcination temperature was set at 400° C. A black calcined material (0.35 g, which corresponds to a recovery of 85%, based on the weight of the charged raw materials (100%)) was obtained.

### Comparative Example 3: Production of Calcined Material (12) by Calcining Only 2,3,6,7,10,11-Hexahydroxytriphenylene

Production was conducted by substantially the same method as in Example 1 except that only 2,3,6,7,10,11-hexahydroxytriphenylene (manufactured by Tokyo Chemical Industry Co., Ltd.; 0.21 g) was used as a raw material, and that the calcination temperature was set at 350° C. A black calcined material (0.18 g, which corresponds to a recovery of 86%, based on the weight of the charged raw material (100%)) was obtained.

### Example 10: Production of Calcined Material (13

Production was conducted by substantially the same method as in Example 1 except that a mixture (0.63 g) obtained by mixing carbon nanotube (VGCF (registered trademark)-X, manufactured by Showa Denko K.K.; 0.32 g) and phloroglucinol (manufactured by FUJIFILM Wako Pure Chemical Corporation, Ltd.; 0.32 g) using a mortar was used as a raw material. A black calcined material (0.52 g, which corresponds to a recovery of 82%, based on the weight of the charged raw materials (100%)) was obtained.

### Example 11: Production of Complex (A) of Calcined Material (1) and Rare Earth Metal Ion

Calcined material (1) (1.00 g) produced in Example 1, tetrahydrofuran (50 mL), and tris(acetylacetonato)cerium(III) trihydrate (manufactured by FUJIFILM Wako Pure Chemical Corporation, Ltd.; 4.67 g, 9.50 mmol) were successively placed in a reaction vessel. Then, a powder of sodium hydride (240.0 mg, 10.0 mmol) was added portion by portion to the reaction vessel. The reaction mixture was placed in an oil bath set at 70° C., and stirred for 24 hours to perform a reaction. After completion of the reaction, the temperature was reduced to 20 to 25° C. which is room temperature, and then ion-exchanged water (10 mL) and 2 mol/L sulfuric acid (20 mL) were added to the reaction vessel in this order, and the resultant mixture was stirred for one hour. Then, the reaction mixture was subjected to filtration using a vacuum filter having silica filter paper attached, and then washed with 2 mol/L sulfuric acid (10 mL). Then, the collected product was washed with ion-exchanged water until the hydrogen ion exponent (pH) of the filtrate became a neutral value. The resultant crude product was placed in an eggplant-shaped flask, and then the flask was set in an evaporator connected to a vacuum pump, and the product was dried at a bath temperature of 90° C. until it had a constant weight, obtaining complex (A) in the form of a black solid (1.792 g).

### Example 12: Production of Complex (B) of Calcined Material (1) and Rare Earth Metal Ion

Calcined material (1) (0.60 g) produced in Example 1, tetrahydrofuran (30 mL), and samarium triisopropoxide (manufactured by FUJIFILM Wako Pure Chemical Corporation, Ltd.; 2.00 g, 6.10 mmol) were successively placed in a reaction vessel. Then, a powder of sodium hydride (240.0 mg, 10.0 mmol) was added portion by portion to the reaction vessel. The reaction mixture was placed in an oil bath set at 70° C., and stirred for 24 hours to perform a reaction. After completion of the reaction, the temperature was reduced to 20 to 25° C. which is room temperature, and then ion-exchanged water (5 mL) and 2 mol/L sulfuric acid (10 mL) were added to the reaction vessel in this order, and the resultant mixture was stirred for one hour. Then, the reaction mixture was subjected to filtration using a vacuum filter having silica filter paper attached, and then washed with 2 mol/L sulfuric acid (5 mL). Then, the collected product was washed with ion-exchanged water until the hydrogen ion exponent (pH) of the filtrate became a neutral value. The resultant crude product was placed in an eggplant-shaped flask, and then the flask was set in an evaporator connected to a vacuum pump, and the product was dried at a bath temperature of 90° C. until it had a constant weight, obtaining complex (B) in the form of a black solid (0.779 g).

### Example 13: Production of Complex (C) of Calcined Material (1) and Rare Earth Metal Ion

A mixture (2.09 g) obtained by mixing calcined material (1) (0.60 g) produced in Example 1 and tris(acetylacetonato)cerium(III) trihydrate (manufactured by FUJIFILM Wako Pure Chemical Corporation, Ltd.; 1.05 g, 2.12 mmol) using a mortar was placed in an alumina crucible. The crucible was set in bench gas replacement furnace KDF-75 (manufactured by Denken-Highdental Co., Ltd.), and a nitrogen gas atmosphere was made using a nitrogen gas flow, and then the temperature was increased at a rate of 13° C. per minute, and calcination was conducted at a calcination temperature of 400° C. for one hour. After the calcination, the temperature was reduced to room temperature while maintaining the nitrogen gas atmosphere, obtaining complex (C) in the form of a black calcined material (0.85 g, which corresponds to a recovery of 51%, based on the weight of the charged raw materials (100%)).

### Comparative Test Example 4 (Calcined Material (7

An MEA was formed in substantially the same manner as in Test Example 1 except that, instead of calcined material (1), 8.0 mg of calcined material (7) was used in the catalyst ink preparation in Comparative Test Example 4. Using the formed MEA, electricity generation test A for fuel cell was conducted. The results of the measurement of voltage and current density are shown in Table 2.

The OCV in Comparative Test Example 4 was 0.953 V.

The electricity generation properties had excellent results in Test Example 1, as compared to the electricity generation properties in Comparative Test Examples 4 and 2 in which an electricity generation test for fuel cell was conducted under substantially the same conditions as in Test Example 1 except that the materials added were changed. From this, it is found that, by using the calcined material of a mixture of the aromatic compound having a phenolic hydroxyl group and the carbon material having electrical conductivity, excellent electricity generation properties are exhibited, as compared to those obtained when using the calcined material of the aromatic compound having a phenolic hydroxyl group alone and the calcined material of the carbon material having electrical conductivity alone.

### Test Example 6

An MEA was formed in substantially the same manner as in Test Example 1 except that, instead of Nafion membrane 212 (thickness: 50 μm) used in Test Example 1, Nafion membrane 211 (thickness: 25 μm) was used. Using the formed MEA, electricity generation test A for fuel cell was conducted. The results of the measurement of voltage and current density are shown in Table 2. The OCV was 0.972 V.

From the results of Test Example 6, it was found that, by using the Nafion membrane having a thickness smaller than that in Test Example 1, the proton conductive properties in the electrolyte membrane were improved, so that the electricity generation properties were further improved.

TABLE 2

| | Electricity generation test | | | |
|---|---|---|---|---|
| | | | Comparative | Comparative |
| | Test | Test | Test | Test |
| | Example 1 | Example 6 | Example 4 | Example 2 |
| Material | Calcined | Calcined | Calcined | Ketjen |
| | material | material | material | black EC |
| | (1) | (1) | (7) | (EC300J) |
| Thickness (μm) of | 50 | 25 | 50 | 50 |
| polymer electrolyte | | | | |
| membrane | | | | |
| Current density | | | | |
| (A/cm²) | Voltage (V) | | | |
| 0.30 | 0.77 | 0.77 | 0.71 | 0.62 |
| 0.50 | 0.73 | 0.73 | 0.64 | 0.54 |
| 1.00 | 0.65 | 0.67 | 0.45 | 0.29 |
| 1.45 | — | — | 0.20 | — |
| 1.50 | 0.57 | 0.60 | — | — |
| 1.64 | — | — | — | — |
| 2.00 | 0.48 | 0.54 | — | — |
| 2.50 | 0.36 | 0.45 | — | — |
| 2.89 | 0.20 | — | — | — |
| 3.00 | — | 0.32 | — | — |
| 3.34 | — | 0.20 | — | — |

### Test Examples 7 to 11

An MEA was formed in substantially the same manner as in Test Example 1 except that, in the catalyst ink preparation, instead of calcined material (1), 8.0 mg of calcined material (8) was used in Test Example 7, 8.0 mg of calcined material (9) was used in Test Example 8, 8.0 mg of calcined material (10) was used in Test Example 9, 8.0 mg of calcined material (11) was used in Test Example 10, or 8.0 mg of calcined material (13) was used in Test Example 11. Using the formed MEA, electricity generation test A for fuel cell was conducted. The results of the measurement of voltage and current density are shown in Table 3. The OCV in Test Example 7 was 0.971 V, the OCV in Test Example 8 was 0.950 V, the OCV in Test Example 9 was 0.988 V, the OCV in Test Example 10 was 0.981 V, and the OCV in Test Example 11 was 9.651 V.

TABLE 3

| | Electricity generation test | | | | |
|---|---|---|---|---|---|
| | Test | Test | Test | Test | Test |
| | Example | Example | Example | Example | Example |
| | 7 | 8 | 9 | 10 | 11 |
| Material | Calcined | Calcined | Calcined | Calcined | Calcined |
| | material | material | material | material | material |
| | (8) | (9) | (10) | (11) | (13) |
| Current | | | | | |
| density | | | | | |
| (A/cm²) | Voltage (V) | | | | |
| 0.30 | 0.76 | 0.75 | 0.77 | 0.76 | 0.78 |
| 0.50 | 0.72 | 0.69 | 0.73 | 0.72 | 0.74 |
| 1.00 | 0.63 | 0.57 | 0.64 | 0.63 | 0.67 |
| 1.50 | 0.55 | 0.44 | 0.55 | 0.54 | 0.59 |
| 2.00 | 0.45 | 0.25 | 0.43 | 0.43 | 0.49 |
| 2.48 | — | 0.20 | — | — | — |
| 2.50 | 0.30 | — | 0.26 | 0.26 | 0.35 |
| 2.64 | — | — | 0.20 | 0.20 | — |
| 2.77 | 0.20 | — | — | — | — |
| 2.94 | — | — | — | — | 0.20 |

### Test Examples 12 and 13

An MEA was individually formed in substantially the same manner as in Test Example 1 except that, instead of calcined material (1), complex (B) was used in Test Example 12, or complex (C) was used in Test Example 13. Using the formed MEA, electricity generation test A for fuel cell was conducted. The results of the measurement of voltage and current density are shown in Table 4. The OCV in Test Example 12 was 0.964 V, and the OCV in Test Example 13 was 0.980 V.

TABLE 4

| Electricity generation test | Test Example 12 | Test Example 13 |
|---|---|---|
| Material | Complex (B) | Complex (C) |
| Current density | Voltage | Voltage |
| (A/cm²) | (V) | (V) |
| 0.30 | 0.73 | 0.79 |
| 0.50 | 0.68 | 0.75 |
| 1.00 | 0.58 | 0.67 |
| 1.50 | 0.48 | 0.58 |
| 2.00 | 0.38 | 0.45 |
| 2.50 | 0.22 | 0.26 |
| 2.56 | 0.20 | 0.24 |
| 2.63 | — | 0.20 |

From Test Examples 7 to 13 above, it is apparent that the calcined material of the present invention and the complex of a rare earth metal and the calcined material exhibit excellent electricity generation properties. The reason why a voltage of 0.2 V or more can be maintained in the present electricity generation test even when the current density is in the region of 2 to 2.5 (A/cm²) is presumed that the formed water well flows and diffusion of oxygen (air) as a fuel is improved, and it is considered that the catalyst layer is improved in the water transport and gas permeability. Further, it is considered that the calcined material and complex of the present invention have a hydroxyl group and therefore the proton receiving and giving effect is improved, and that the complex of the present invention is a complex of a rare earth metal and therefore, the effect of coordination of a great amount of water to the metal center of the rare earth metal complex improves the proton conductive properties.

### INDUSTRIAL APPLICABILITY

The calcined material and complex of the present invention are advantageously used as, for example, electrolyte materials for a fuel cell (such as an electrolyte and a catalyst carrier used in a catalyst layer, and an electrolyte in a polymer electrolyte membrane), and expected to improve the fuel cell in electricity generation properties and durability.

### DESCRIPTION OF REFERENCE NUMERALS

100: Fuel cell
101: Gas diffusion layer
103: Anode catalyst layer
105: Cathode catalyst layer
107: Polymer electrolyte membrane
109: Separator

1. A carbon-based calcined material of a mixture of an aromatic compound having a phenolic hydroxyl group and a carbon material having electrical conductivity.

2. The carbon-based calcined material according to claim 1, wherein the aromatic compound having a phenolic hydroxyl group is an aromatic compound having 2 to 6 phenolic hydroxyl groups.

3. The carbon-based calcined material according to claim 1, wherein the carbon material having electrical conductivity is at least one kind selected from the group consisting of ketjen black, ketjen black EC, and carbon nanotube.

4. A method for producing the carbon-based calcined material according to claim 1, the method comprising the step of obtaining a mixture of a fused liquid or organic solvent solution of an aromatic compound having a phenolic hydroxyl group and a carbon material having electrical conductivity.

5. The method for producing the carbon-based calcined material according to claim 4, wherein the method comprises the steps of:
(step 1) obtaining a mixture of an aromatic compound having a phenolic hydroxyl group and a carbon material having electrical conductivity, and
(step 2) calcining the mixture obtained in the step 1 at a temperature which is the melting point of the aromatic compound having a phenolic hydroxyl group or higher.

6. The method for producing the carbon-based calcined material according to claim 4, wherein the method comprises the steps of:
(step 1) obtaining a mixture of an organic solvent solution of an aromatic compound having a phenolic hydroxyl group and a carbon material having electrical conductivity, and
(step 2) calcining the mixture obtained in the step 1 at a temperature in the range of from 150 to 600° C.

7. A complex of the calcined material according to claim 1 and a rare earth metal ion, wherein the rare earth metal ion and the substituent of the calcined material form a complex.

8. The complex according to claim 7, wherein the metal species of the rare earth metal ion is at least one kind selected from the group consisting of scandium, yttrium, lanthanum, cerium, praseodymium, neodymium, promethium, samarium, europium, gadolinium, terbium, dysprosium, holmium, erbium, thulium, ytterbium, and lutetium.

9. The complex according to claim 7, wherein the substituent of the calcined material is at least one kind selected from the group consisting of a hydroxyl group, a carboxyl group, a carbonyl group, a formyl group, a sulfonic acid group, an oxysulfonic acid group, a carboxylic acid anhydride structure, a chromene structure, a lactone structure, an ester structure, and an ether structure, which are derived from the carbon material having electrical conductivity, and a hydroxyl group derived from the aromatic compound having a phenolic hydroxyl group.

10. A method for producing the complex according to claim 7, the method comprising reacting a rare earth metal compound and the calcined material in a solvent.

11. The method for producing according to claim 10, wherein the rare earth metal compound is at least one kind selected from the group consisting of CeBr₃, CeCl₃·7H₂O, CeF₃, CeF₄, CeI₃, EuBr₃·xH₂O, EuCl₂, EuCl₃, EuCl₃·6H₂O, EuF₃, EuI₂, NdBr₃, NdCl₃, NdCl₃·6H₂O, NdF₃, NdI₂, NdI₃, SmBr₃, SmCl₃, SmCl₃·6H₂O, SmI₂, SmI₃, Ce(NH₄)₂(NO₃)₆, Ce(NO₃)₃·6H₂O, Nd(NO₃)₃·6H₂O, Ce(CH₃CO₂)₃·xH₂O, Ce(C₅H₇O₂)₃·xH₂O, Eu(CH₃CO₂)₃·xH₂O, CeO₂, Eu₂O₃, Nd₂O₃, Sm₂O₃, Sc₂O₃, (CeO₂)(ZrO₂), and samarium triisopropoxide.

12. A method for producing the complex according to claim 7, the method comprising calcining a mixture of a rare earth metal compound and the calcined material.

13. The method for producing according to claim 12, wherein the rare earth metal compound is at least one kind selected from the group consisting of Ce(CH₃CO₂)₃·xH₂O, Ce(C₅H₇O₂)₃·xH₂O, Eu(CH₃CO₂)₃·xH₂O, Gd(CH₃CO₂)₃·xH₂O, Gd(C₅H₇O₂)₃·xH₂O, La(CH₃CO₂)₃·xH₂O, La(C₅H₇O₂)₃·xH₂O, Tb(CH₃CO₂)₃·xH₂O, Yb(C₂H₃O₂)₃·4H₂O, cerium triisopropoxide, samarium triisopropoxide, tris(acetylacetonato)cerium(III), and tris(acetylacetonato)samarium(III).

14. The calcined material according to claim 1 or the complex according claim 7, which is at least one kind of an electrolyte in a catalyst layer, a catalyst carrier in the catalyst layer, and an electrolyte in a polymer electrolyte membrane, for a polymer electrolyte fuel cell.

15. A composition comprising at least one of the calcined material of claim 1 or the complex according to claim 7, and a metal catalyst.

16. The composition according to claim 15, which is for use in a catalyst layer for a polymer electrolyte fuel cell.

17. A catalyst layer for a polymer electrolyte fuel cell, the catalyst layer comprising the composition according to claim 15.

18. A membrane electrode assembly comprising a polymer electrolyte membrane, a gas diffusion layer, and the catalyst layer for a polymer electrolyte fuel cell according to claim 17.

19. The membrane electrode assembly according to claim 18, wherein the polymer electrolyte membrane has a thickness of 10 to 100 μm.

20. A polymer electrolyte fuel cell comprising the membrane electrode assembly according to claim 18.

21. A method for using the composition according to claim 15 in a catalyst layer for a polymer electrolyte fuel cell.
